(19) United States
(12) Patent Application Publication
(10) Pub. No.: US 2019/0224937 A1
(43) Pub. Date: Jul. 25, 2019

(54) SYSTEMS, DEVICES, AND METHODS FOR MANUFACTURE AND USE OF LAMINATED SHEET METALS

(71) Applicant: PATENT PORTFOLIO LICENSING, LLC, White Plains, NY (US)

(72) Inventors: Carl Fanelli, Mahopac, NY (US); Glen Bernardi, Baldwin Place, NY (US); Lisa DeRosa Panitz, White Plains, NY (US)

(21) Appl. No.: 16/332,467

(22) PCT Filed: Jul. 26, 2017
(86) PCT No.: PCT/US17/43951

§ 371 Date: Mar. 12, 2019

Related U.S. Application Data
(60) Provisional application No. 62/393,992, filed on Sep. 13, 2016.

(51) Int. Cl. B32B 1/08; B32B 15/09; B32B 15/18; B32B 15/20; B32B 37/12; B32B 7/12; F16L 23/036; F16L 9/00; B32B 37/00; F24F 13/02

(52) U.S. Cl. CPC B32B 1/08; B32B 15/09; B32B 15/18; B32B 15/20; B32B 37/12; B32B 2419/00; F16L 23/036; F16L 9/003; B32B 37/0053; F24F 13/0245; B32B 7/12

(57) ABSTRACT

Various laminated compositions comprising sheet metal, methods of manufacture, and use thereof are disclosed.

### CROSS-REFERENCE TO RELATED APPLICATIONS

This application claims a benefit of U.S. Provisional Patent Application 62/393,992, filed on 13 Sep. 2016, which is herein fully incorporated by reference for all purposes.

### TECHNICAL FIELD

The present disclosure relates to laminated sheet metals.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

Conventional sheet metals can be used for many applications, such as ductwork or tubing in heating, ventilation, and air conditioning (HVAC) systems. For example, an HVAC system is generally used to provide a comfortable air environment, whether indoors or in a vehicular cabin. For example, the HVAC system can provide temperature comfort or acceptable air quality in a building, whether residential or commercial. Accordingly, the HVAC system typically contains a ductwork, which includes a set of interconnected ducts configured to conduct forced air therethrough.

Installation, use, or maintenance of the HVAC system is generally regulated by a legal code, such as a local building code. Among other things, the legal code often mandates that the ductwork of the HVAC system be insulated, such as during installation, use, or maintenance of the HVAC system. One reason for such mandate is to encourage efficiency in energy use. Resultantly, when the HVAC system is in operation, the insulation reduces thermal energy transfer between the forced air within the ductwork of the HVAC system and ambient air outside the ductwork of the HVAC system. Such reduction of the thermal energy transfer encourages efficiency in energy use.

One method of insulating the ductwork of the HVAC system, for compliance with the legal code, involves wrapping an insulation jacket around many, if not all, of the ducts of the ductwork of the HVAC system and then sealing, such as via a tape, any remaining seams in the ductwork of the HVAC system, outside of the insulation jacket. Subsequently, the HVAC system is pressure tested to ensure absence of substantial leaks of the forced air from within the ductwork of the HVAC system to outside the ductwork of the HVAC system. Although such method is sometimes effective, various drawbacks remain. For example, the method can be time consuming or costly to implement.

### SUMMARY

The present disclosure at least partially addresses at least one of the above. However, the present disclosure can prove useful to other technical areas. Therefore, the claims should not be construed as necessarily limited to addressing any of the above.

Among various aspects of the present disclosure is a provision of compositions of laminate sheet metal and methods of preparing the same.

One embodiment provides a method for producing a laminated sheet metal material including contacting a laminate coating composition, an adhesive, and a sheet metal under a condition sufficient to form a laminated sheet metal.

Another embodiment provides a composition including a laminate coating composition, an adhesive, and a sheet metal, wherein the laminate coating composition comprises a polymer.

Another embodiment provides a composition formed by contacting a laminate coating composition, an adhesive, and a sheet metal under conditions sufficient to form a laminated sheet metal.

Another embodiment provides a laminated sheet metal including (i) a first sheet metal in contact with a first adhesive in contact with a first plastic sheet in contact with a second adhesive in contact with a second plastic sheet in contact with a second metal sheet; or (ii) a first plastic sheet in contact with a first adhesive in contact with a sheet metal in contact with an adhesive in contact with a plastic sheet.

Another embodiment provides a device comprising a laminated material including a first layer, a second layer, and a third layer, wherein the first layer includes a sheet metal, wherein the second layer includes an adhesive, wherein the third layer includes a plastic, wherein the second layer extends between the first layer and the third layer.

Another embodiment provides a method comprising: coupling a duct to a source of a fluid, wherein the duct includes a laminated material including a first layer, a second layer, and a third layer, wherein the first layer includes a sheet metal, wherein the second layer includes an adhesive, wherein the third layer includes a plastic, wherein the second layer extends between the first layer and the third layer; and conducting the fluid through the duct such that the first layer is exposed to the fluid.

Another embodiment provides a method comprising: inputting a sheet metal, an adhesive, and a plastic into a laminator; and receiving a web of a material from the laminator, wherein the material includes a first layer, a second layer, and a third layer, wherein the first layer includes the sheet metal, wherein the first layer is outermost, wherein the second layer includes the adhesive, wherein the third layer includes the plastic, wherein the second layer extends between the first layer and the third layer.

Another embodiment provides a device comprising: a first duct including a first coupling portion, wherein the first coupling portion includes a first U-shaped portion and a first L-shaped portion, wherein the first L-shaped portion extends from the first U-shaped portion such that a first J-shaped portion is defined; a second duct including a second coupling portion, wherein the second coupling portion includes a second U-shaped portion and a second L-shaped portion, wherein the second L-shaped portion extends from the second U-shaped portion such that a second J-shaped portion is defined; and a coupler including a third U-shaped portion, a first tail portion, and a second tail portion, wherein the first tail portion and the second tail portion extend from the third U-shaped portion toward each other, wherein the first tail portion engages the first J-shaped portion and the second tail portion engages the second J-shaped portion such that the first duct is in fluid communication with the second duct.

### BRIEF DESCRIPTION OF DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 is an image of a top view of a laminated stainless steel sheet formed according to Example 1.

FIG. 2 is an image of a top view of a laminated stainless steel sheet formed according to Example 1 demonstrating the flexibility.

FIG. 3 is an image of a side view of a laminated stainless steel sheet formed according to Example 1 demonstrating the thinness.

FIG. 4 is an image of a laminated stainless steel sheet formed according to Example 1.

FIG. 5 is a diagram of an embodiment of a ductwork according to this disclosure.

FIG. 6 is a diagram of an embodiment of a ductwork containing an insulator according to this disclosure.

FIG. 7 is a diagram of an embodiment of a ductwork containing a mineral wool fiber according to this disclosure.

FIG. 8 is a diagram of an embodiment of a pair of ducts prior to coupling according to this disclosure.

FIG. 9 is a diagram of an embodiment of a ductwork and a duct prior to coupling according to this disclosure.

FIG. 10 is a cross-sectional diagram of an embodiment of a duct according to this disclosure.

FIG. 11 is an image of a pair of ducts coupled via a coupler according to this disclosure.

FIG. 12 is an image of a duct with a copper inner surface according to this disclosure.

FIG. 13 is an image of a duct with a stainless steel inner surface according to this disclosure.

FIG. 14 is an image of a coupler engaging a first duct end portion and a second duct end portion according to this disclosure.

FIG. 15 is an image of a pair of ducts with different inner surfaces prior to coupling via a coupler according to this disclosure.

FIG. 16 is an image of a duct with an inner tube, an insulator, and an outer tube according to this disclosure.

### DETAILED DESCRIPTION

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, a gemstone, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

As used herein, the term “about” and/or “substantially” refers to a +/−10% variation from the nominal value/term. Such variation is always included in any given value/term provided herein, whether or not such variation is specifically referred thereto.

If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

This disclosure relates to systems, devices, compositions, and methods of making and using a material comprising a laminated sheet metal. This disclosure is based at least in part on a discovery that a thin sheet comprising a metal encapsulated in a plastic sheet provided for a strong, durable, flexible, and lightweight material for various uses including, for example, ductwork, tubing, heating, ventilation, refrigeration, piping, fluid conduction, plumbing fixtures, gutters, containers, toys, sporting equipment, eating utensils, medical devices, automotive/aerospace/marine technology, packaging, and others. This material was found to be as durable as heavier, more expensive stainless steel materials as evidenced by a flame test in Example 3. For example, this material can include a metal, an adhesive, and a plastic, where the adhesive is interposed between the metal and plastic. For example, this material can include a metal and a plastic, where the metal and plastic are thermally bonded to each other. The laminated sheet metal as described herein is stronger and more durable than the sheet metal not having lamination. For example, a tensile strength or a typical yield strength of the laminated sheet metal is greater than a tensile strength or a typical yield strength of the sheet metal without lamination. The laminated sheet metal as described herein has a greater structural stability than the sheet metal without lamination. The laminated sheet metal and components thereof can be of any thickness such that the laminated sheet metal remains flexible. For example, flexibility can be understood as capable of bending without breaking or can be understood as not rigid. The laminated sheet metal components can be comprised of recycled laminate material (e.g., PET plastic from water bottles), recycled polymer, recycled adhesive material, or recycled metal. In some embodiments, the material, as disclosed herein, can include a signal or energy conductor, such as an electrically conductive layer or wire or optical fiber, laminated therein or externally disposed over or secured onto the material, such as via friction, adhering, fastening, bracketing, magnetizing, mating, interlocking, brazing, bonding, stapling, nailing, or others. For example, as laminated, the signal or energy conductor can be in contact with the sheet metal, the adhesive, or the plastic in any permutational strata arrangement within the material. For example, within the material, the signal or energy conductor can be positioned between the adhesive and the plastic or between the adhesive and the sheet metal or over the sheet metal such that the sheet metal is between the signal or energy conductor and the adhesive or over the plastic such that the plastic is between the signal or energy conductor and the adhesive, any of which may include physical contact, whether direct or indirect. Alternatively, the sheet metal, the adhesive, or the plastic is able to function as the signal or energy conductor to conduct an electrical charge or signal or an optical signal. If the signal or energy conductor is included with the material, whether internal to the material, such as laminated therein, or external to the material, such as disposed over or secured to the material, then the material, such as when in sheet form, may peripherally host a terminal, such as along an outer perimeter of the sheet, including an end portion thereof, such as a terminal coupler or a terminal block, such as used in photovoltaic cell coupling, in signal communication with the signal or energy conductor. For example, the terminal may be U-shaped and frictionally, such as via clamping, and adhesively engaging the sheet or physically secured to the sheet, such as via fastening, mating, or others. For example, the terminal coupler or terminal block can be similar to what is disclosed in U.S. Pat. No. 2,768,362, which is herein fully incorporated by reference for all purposes. As such, the material, such as when in sheet form, may be used to conduct electrical or optical energy or signals.

### Laminate

As described herein a laminate can be a coating. For example, a laminate can be a coating, an overlay, a surface, a fascia, a resin, a glaze, a veneer, a wrap, a liner, a film, or a cover. A laminate can encapsulate or envelop a substrate.

A laminate material, as described herein, can comprise any material suitable for providing a laminate, coating, overlay, surface, fascia, glaze, veneer, or cover. As an example, the laminate material, as described herein, can comprise a sheet or glaze.

A laminated structure or material, as described herein can be made with one or more layers of components. For example, multiple layers of laminate, adhesive, or sheet metal can form a hard, flat, rigid, or flexible material.

A material can be comprised of multiple layers, so that the composite material achieves improved strength, stability, sound insulation, appearance or other properties from the use of differing materials.

A laminate material can be sufficient to provide greater structural stability, greater tensile strength, or greater typical yield strength of the laminated sheet metal compared to the sheet metal without lamination.

### Laminate Coating Composition

A laminate coating composition can be any material suitable to laminate, cover, or coat a surface (e.g., sheet metal, adhesive on sheet metal). For example, a laminate material can comprise a polymer. A polymer suitable for use as a laminate can be any conventional polymer (see e.g., Nair et al. Prog. Poly. Sci 2007 32(8-9) 762-798; Miller Chou et al. Prog. Poly. Sci 2003 28 1223-1270). For example, a polymer can include polyethylene terephthalate (PET), recycled PET (rPET), nylon 610, nylon 8, polypropylene, polystyrene, cotton, rayons, hemp, polycarbonate, polyacetal, polyvinyl chloride, polyvinyl alcohol, nylon 6, nylon 610, polyethylene, ABS resins, PVC, melamine, melamine adhesive, Polypropylene, HDPE, LDPE, PETE, PETP, PET P, CPET, Dacron, Terylene, Laysan, Eastabond, Eastapak, Ektar, Grilpet, Impet, Kodapak, Kodar, Petra, Rynite, Sabre, Selar, Stanuloy, Valox, Celanex, Eastpac, Ektar, Mylar, Arnite, Centrolyte, Ertalyte, acrylic resin, alginate, caprolactone, collagen, chitosan, hyaluronic acid, hydrogel, hydroxybutyric acid, polyanhydride, polycaprolactone (PCL), poly(dimethylglycolic acid), polydioxanone (PDO), polyester, polyethylene, poly(ethylene glycol), poly(glycolide) (PGA), poly(glycolic acid), polyhydroxobutyrate, poly(2-hydroxyethyl-methacrylate), poly-lactide-co-glycolide (PLCG), poly(D,L-lactide-co-glycolide) (PLG), poly(lactide-co-glycolic acid) (PLGA), polylactide (PLA), polylactic acid (PLLA), poly-lactide-co-glycolide (PLCG), poly(methylethylglycolic acid), polymethylmethacrylate, polyphosphazenes, polyphosphoesters, polypropylene, poly(propylene fumarate), polyurethane (PU), or silicone rubber, or combinations or copolymers thereof. In some embodiments, the polymer can include a bioresorbable polyester or a copolymer selected from one or more of the group consisting of polycaprolactone (PCL), poly(D,L-lactide-co-glycolide) (PLG), polylactide (PLA), polylactic acid (PLLA), or poly-lactide-co-glycolide (PLCG). Nonlimiting examples of suitable polymers can include polycaprolactone, polylactide, polyglycolide, poly(lactide-glycolide), poly(propylene fumarate), poly(caprolactone fumarate), polyethylene glycol, poly(glycolide-co-caprolactone), polysaccharides (e.g., alginate), chitosan, polyphosphazene, polyacrylate, polyethylene oxide-polypropylene glycol block copolymer, fibrin, collagen, fibronectin, polyvinylpyrrolidone, hyaluronic acid, polycarbonates, polyamides, polyanhydrides, polyamino acids, polyortho esters, polyacetals, polycyanoacrylates, polyurethanes, polyacrylates, ethylene-vinyl acetate polymers or other acyl substituted cellulose acetates or derivatives thereof, or analogs, mixtures, combinations or derivatives of any of the above.

The laminate coating composition can also comprise fibers (e.g., cotton, yarn, hemp, rayon, cloth) or colorant.

A polymer, as described herein can comprise recycled PET (rPET) or PET bottles, thermoforms, or bales that contain a mixture of bottles and thermoforms. As another example, a polymer can comprise recycled plastic waste materials such as PET, polyethylene terephthalate, from 2-1 soda bottles; HDPE, high density polyethylene, natural, from 1 gallon milk jugs, grocery bags, HDPE, high density polyethylene, colored, from bottles, PVC, polyvinyl chloride, various bottle, pipes, flooring; LDPE, low density polyethylene, from film and trash bags, rigid containers; PP, polypropylene, from some food containers, battery cases, medical containers, PS, polystyrene, from carry-out containers, food containers, or vitamin bottles.

Polymers, as described herein, can be high molecular weight or low molecular weight. For example, a laminate coating composition or a polymer can have an average molecular weight between about 1,000 g/mol and about 100,000 g/mol. For example, the laminate coating composition can comprise a polymer with or the laminate coating composition can have an average molecular weight of about 1,000 g/mol; about 2,000 g/mol; about 3,000 g/mol; about 4,000 g/mol; about 5,000 g/mol; about 6,000 g/mol; about 7,000 g/mol; about 8,000 g/mol; about 9,000 g/mol; about 10,000 g/mol; about 11,000 g/mol; about 12,000 g/mol; about 13,000 g/mol; about 14,000 g/mol; about 15,000 g/mol; about 16,000 g/mol; about 17,000 g/mol; about 18,000 g/mol; about 19,000 g/mol; about 20,000 g/mol; about 21,000 g/mol; about 22,000 g/mol; about 23,000 g/mol; about 24,000 g/mol; about 25,000 g/mol; about 26,000 g/mol; about 27,000 g/mol; about 28,000 g/mol; about 29,000 g/mol; about 30,000 g/mol; about 31,000 g/mol; about 32,000 g/mol; about 33,000 g/mol; about 34,000 g/mol; about 35,000 g/mol; about 36,000 g/mol; about 37,000 g/mol; about 38,000 g/mol; about 39,000 g/mol; about 40,000 g/mol; about 41,000 g/mol; about 42,000 g/mol; about 43,000 g/mol; about 44,000 g/mol; about 45,000 g/mol; about 46,000 g/mol; about 47,000 g/mol; about 48,000 g/mol; about 49,000 g/mol; about 50,000 g/mol; about 51,000 g/mol; about 52,000 g/mol; about 53,000 g/mol; about 54,000 g/mol; about 55,000 g/mol; about 56,000 g/mol; about 57,000 g/mol; about 58,000 g/mol; about 59,000 g/mol; about 60,000 g/mol; about 61,000 g/mol; about 62,000 g/mol; about 63,000 g/mol; about 64,000 g/mol; about 65,000 g/mol; about 66,000 g/mol; about 67,000 g/mol; about 68,000 g/mol; about 69,000 g/mol; about 70,000 g/mol; about 71,000 g/mol; about 72,000 g/mol; about 73,000 g/mol; about 74,000 g/mol; about 75,000 g/mol; about 76,000 g/mol; about 77,000 g/mol; about 78,000 g/mol; about 79,000 g/mol; about 80,000 g/mol; about 81,000 g/mol; about 82,000 g/mol; about 83,000 g/mol; about 84,000 g/mol; about 85,000 g/mol; about 86,000 g/mol; about 87,000 g/mol; about 88,000 g/mol; about 89,000 g/mol; about 90,000 g/mol; 91,000 g/mol; about 92,000 g/mol; about 93,000 g/mol; about 94,000 g/mol; about 95,000 g/mol; about 96,000 g/mol; about 97,000 g/mol; about 98,000 g/mol; about 99,000 g/mol; or about 100,000 g/mol. It is understood that recitation of the above discrete values includes a range between each recited value. It is understood that recitation of the above ranges includes a discrete values between each recited range.

In addition to the above mentioned polymers, the laminate coating composition may contain auxiliary components comprising other high polymers, reinforcing agents or fillers, or, or mixture thereof. For example, auxiliary components can be nylon 6, nylon 66, nylon 610, nylon 8, polybutylene terephthalate (PBT), polyethylene, polypropylene, ABS resins, cotton, rayons, and hemp. Examples of the reinforcing agents or fillers are glass fibers, glass beads, glass powders, quartz, talc, cement, and powders and fibers of carbon, iron, copper, titanium oxide, molybdenum, or aluminum and any other materials which are compatible with the polymer.

If necessary, other additives such as pigments, dyes, fire-retarding chemicals and deterioration preventing agents may also be incorporated into the laminate coating composition in conjunction with the above described auxiliary components (e.g., high polymer or filler).

As described herein, a laminate coating composition can comprise a polymer. For example, the laminate coating composition can comprise any of the above polymers, derivatives or analogs thereof, auxiliary components, or mixtures thereof in an amount of about 1%, about 2%, about 3%, about 4%, about 5%, about 6%, about 7%, about 8%, about 9%, about 10%, 11%, about 12%, about 13%, about 14%, about 15%, about 16%, about 17%, about 18%, about 19%, about 20%, 21%, about 22%, about 23%, about 24%, about 25%, about 26%, about 27%, about 28%, about 29%, about 30%, 31%, about 32%, about 33%, about 34%, about 35%, about 36%, about 37%, about 38%, about 39%, about 40%, 41%, about 42%, about 43%, about 44%, about 45%, about 46%, about 47%, about 48%, about 49%, about 50%, 51%, about 52%, about 53%, about 54%, about 55%, about 56%, about 57%, about 58%, about 59%, about 60%, 61%, about 62%, about 63%, about 64%, about 65%, about 66%, about 67%, about 68%, about 69%, about 70%, 71%, about 72%, about 73%, about 74%, about 75%, about 76%, about 77%, about 78%, about 79%, about 80%, 81%, about 82%, about 83%, about 84%, about 85%, about 86%, about 87%, about 88%, about 89%, about 90%, 91%, about 92%, about 93%, about 94%, about 95%, about 96%, about 97%, about 98%, about 99%, or about 100%. It is understood that recitation of the above discrete values includes a range between each recited value. It is understood that recitation of the above ranges includes a discrete values between each recited range.

As described herein, another suitable material for a laminate can be an extruded sheet of plastic comprising plastic from recycled water bottles (e.g., PET).

Laminate coating compositions can comprise layers of the same or different materials, depending on the processes and the object to be laminated. The laminate coating composition can have any width suitable for use for laminating sheet metal. For example, the laminate material can have a width of at least between about 25 inches and about 72 inches. For example, the width of the laminate coating composition can be about 1 inch, about 2 inches, about 3 inches, about 4 inches, about 5 inches, about 6 inches, about 7 inches, about 8 inches, about 9 inches, about 10 inches, 11 inches, about 12 inches, about 13 inches, about 14 inches, about 15 inches, about 16 inches, about 17 inches, about 18 inches, about 19 inches, about 20 inches, 21 inches, about 22 inches, about 23 inches, about 24 inches, about 25 inches, about 26 inches, about 27 inches, about 28 inches, about 29 inches, about 30 inches, 31 inches, about 32 inches, about 33 inches, about 34 inches, about 35 inches, about 36 inches, about 37 inches, about 38 inches, about 39 inches, about 40 inches, 41 inches, about 42 inches, about 43 inches, about 44 inches, about 45 inches, about 46 inches, about 47 inches, about 48 inches, about 49 inches, about 50 inches, 51 inches, about 52 inches, about 53 inches, about 54 inches, about 55 inches, about 56 inches, about 57 inches, about 58 inches, about 59 inches, about 60 inches, 61 inches, about 62 inches, about 63 inches, about 64 inches, about 65 inches, about 66 inches, about 67 inches, about 68 inches, about 69 inches, about 70 inches, 71 inches, about 72 inches, about 73 inches, about 74 inches, about 75 inches, about 76 inches, about 77 inches, about 78 inches, about 79 inches, about 80 inches, 81 inches, about 82 inches, about 83 inches, about 84 inches, about 85 inches, about 86 inches, about 87 inches, about 88 inches, about 89 inches, about 90 inches, 91 inches, about 92 inches, about 93 inches, about 94 inches, about 95 inches, about 96 inches, about 97 inches, about 98 inches, about 99 inches, about 100 inches, 101 inches, about 102 inches, about 103 inches, about 104 inches, about 105 inches, about 106 inches, about 107 inches, about 108 inches, about 109 inches, about 110 inches, 111 inches, about 112 inches, about 113 inches, about 114 inches, about 115 inches, about 116 inches, about 117 inches, about 118 inches, about 119 inches, about 120 inches, 121 inches, about 122 inches, about 123 inches, about 124 inches, or about 125 inches. It is understood that recitation of the above discrete values includes a range between each recited value. It is understood that recitation of the above ranges includes a discrete values between each recited range.

An example of a laminating a material can be the application of a layer of plastic film (e.g., the laminate) on either side of a sheet of material (e.g., sheet metal), wherein the adhesive is placed between the sheet metal and the laminate material.

The laminate material can have any thickness suitable for use in a process for producing a flexible laminated sheet metal. For example, the laminate coating composition can have a thickness of between about 0.1 mil and 125 mil. For example, the laminate coating composition can have a thickness between about 1 mil and about 10 mil. As another example, the laminate film thickness can be about 0.10 mil, about 0.15 mil, about 0.20 mil, about 0.25 mil, about 0.30 mil, about 0.35 mil, about 0.40 mil, about 0.45 mil, about 0.50 mil, about 0.55 mil, about 0.60 mil, about 0.65 mil, about 0.70 mil, about 0.80 mil, about 0.85 mil, about 0.90 mil, about 1.0 mil, about 1.10 mil, about 1.15 mil, about 1.20 mil, about 1.25 mil, about 1.30 mil, about 1.35 mil, about 1.40 mil, about 1.45 mil, about 1.50 mil, about 1.55 mil, about 1.60 mil, about 1.65 mil, about 1.70 mil, about 1.80 mil, about 1.85 mil, about 1.90 mil, about 2.0 mil, about 2.10 mil, about 2.15 mil, about 2.20 mil, about 2.25 mil, about 2.30 mil, about 2.35 mil, about 2.40 mil, about 2.45 mil, about 2.50 mil, about 2.55 mil, about 2.60 mil, about 2.65 mil, about 2.70 mil, about 2.80 mil, about 2.85 mil, about 2.90 mil, about 3.0 mil, about 3.10 mil, about 3.15 mil, about 3.20 mil, about 3.25 mil, about 3.30 mil, about 3.35 mil, about 3.40 mil, about 3.45 mil, about 3.50 mil, about 3.55 mil, about 3.60 mil, about 3.65 mil, about 3.70 mil, about 3.80 mil, about 3.85 mil, about 3.90 mil, about 4.0 mil, about 4.10 mil, about 4.15 mil, about 4.20 mil, about 4.25 mil, about 4.30 mil, about 4.35 mil, about 4.40 mil, about 4.45 mil, about 4.50 mil, about 4.55 mil, about 4.60 mil, about 4.65 mil, about 4.70 mil, about 4.80 mil, about 4.85 mil, about 4.90 mil, about 5.0 mil, about 5.10 mil, about 5.15 mil, about 5.20 mil, about 5.25 mil, about 5.30 mil, about 5.35 mil, about 5.40 mil, about 5.45 mil, about 5.50 mil, about 5.55 mil, about 5.60 mil, about 5.65 mil, about 5.70 mil, about 5.80 mil, about 5.85 mil, about 5.90 mil, about 6.0 mil, about 6.10 mil, about 6.15 mil, about 6.20 mil, about 6.25 mil, about 6.30 mil, about 6.35 mil, about 6.40 mil, about 6.45 mil, about 6.50 mil, about 6.55 mil, about 6.60 mil, about 6.65 mil, about 6.70 mil, about 6.80 mil, about 6.85 mil, about 6.90 mil, about 7.0 mil, about 7.10 mil, about 7.15 mil, about 7.20 mil, about 7.25 mil, about 7.30 mil, about 7.35 mil, about 7.40 mil, about 7.45 mil, about 7.50 mil, about 7.55 mil, about 7.60 mil, about 7.65 mil, about 7.70 mil, about 7.80 mil, about 7.85 mil, about 7.90 mil, about 8.0 mil, about 8.10 mil, about 8.15 mil, about 8.20 mil, about 8.25 mil, about 8.30 mil, about 8.35 mil, about 8.40 mil, about 8.45 mil, about 8.50 mil, about 8.55 mil, about 8.60 mil, about 8.65 mil, about 8.70 mil, about 8.80 mil, about 8.85 mil, about 8.90 mil, about 9.0 mil, about 9.10 mil, about 9.15 mil, about 9.20 mil, about 9.25 mil, about 9.30 mil, about 9.35 mil, about 9.40 mil, about 9.45 mil, about 9.50 mil, about 9.55 mil, about 9.60 mil, about 9.65 mil, about 9.70 mil, about 9.80 mil, about 9.85 mil, about 9.90 mil, about 10.0 mil, about 10.10 mil, about 10.15 mil, about 10.20 mil, about 10.25 mil, about 10.30 mil, about 10.35 mil, about 10.40 mil, about 10.45 mil, about 10.50 mil, about 10.55 mil, about 10.60 mil, about 10.65 mil, about 10.70 mil, about 10.80 mil, about 10.85 mil, about 10.90 mil, about 11.0 mil, about 11.10 mil, about 11.15 mil, about 11.20 mil, about 11.25 mil, about 11.30 mil, about 11.35 mil, about 11.40 mil, about 11.45 mil, about 11.50 mil, about 11.55 mil, about 11.60 mil, about 11.65 mil, about 11.70 mil, about 11.80 mil, about 11.85 mil, about 11.90 mil, about 12.0 mil, about 12.10 mil, about 12.15 mil, about 12.20 mil, about 12.25 mil, about 12.30 mil, about 12.35 mil, about 12.40 mil, about 12.45 mil, about 12.50 mil, about 12.55 mil, about 12.60 mil, about 12.65 mil, about 12.70 mil, about 12.80 mil, about 12.85 mil, about 12.90 mil, about 13.0 mil, about 13.10 mil, about 13.15 mil, about 13.20 mil, about 13.25 mil, about 13.30 mil, about 13.35 mil, about 13.40 mil, about 13.45 mil, about 13.50 mil, about 13.55 mil, about 13.60 mil, about 13.65 mil, about 13.70 mil, about 13.80 mil, about 13.85 mil, about 13.90 mil, about 14.0 mil, about 14.10 mil, about 14.15 mil, about 14.20 mil, about 14.25 mil, about 14.30 mil, about 14.35 mil, about 14.40 mil, about 14.45 mil, about 14.50 mil, about 14.55 mil, about 14.60 mil, about 14.65 mil, about 14.70 mil, about 14.80 mil, about 14.85 mil, about 14.90 mil, about 15.0 mil, about 15.10 mil, about 15.15 mil, about 15.20 mil, about 15.25 mil, about 15.30 mil, about 15.35 mil, about 15.40 mil, about 15.45 mil, about 15.50 mil, about 15.55 mil, about 15.60 mil, about 15.65 mil, about 15.70 mil, about 15.80 mil, about 15.85 mil, about 15.90 mil, about 16.0 mil, about 16.10 mil, about 16.15 mil, about 16.20 mil, about 16.25 mil, about 16.30 mil, about 16.35 mil, about 16.40 mil, about 16.45 mil, about 16.50 mil, about 16.55 mil, about 16.60 mil, about 16.65 mil, about 16.70 mil, about 16.80 mil, about 16.85 mil, about 16.90 mil, about 17.0 mil, about 17.10 mil, about 17.15 mil, about 17.20 mil, about 17.25 mil, about 17.30 mil, about 17.35 mil, about 17.40 mil, about 17.45 mil, about 17.50 mil, about 17.55 mil, about 17.60 mil, about 17.65 mil, about 17.70 mil, about 17.80 mil, about 17.85 mil, about 17.90 mil, about 18.0 mil, about 18.10 mil, about 18.15 mil, about 18.20 mil, about 18.25 mil, about 18.30 mil, about 18.35 mil, about 18.40 mil, about 18.45 mil, about 18.50 mil, about 18.55 mil, about 18.60 mil, about 18.65 mil, about 18.70 mil, about 18.80 mil, about 18.85 mil, about 18.90 mil, about 19.0 mil, about 19.10 mil, about 19.15 mil, about 19.20 mil, about 19.25 mil, about 19.30 mil, about 19.35 mil, about 19.40 mil, about 19.45 mil, about 19.50 mil, about 19.55 mil, about 19.60 mil, about 19.65 mil, about 19.70 mil, about 19.80 mil, about 19.85 mil, about 19.90 mil, about 20.0 mil, about 20.10 mil, about 20.15 mil, about 20.20 mil, about 20.25 mil, about 20.30 mil, about 20.35 mil, about 20.40 mil, about 20.45 mil, about 20.50 mil, about 20.55 mil, about 20.60 mil, about 20.65 mil, about 20.70 mil, about 20.80 mil, about 20.85 mil, about 20.90 mil, about 21.0 mil, about 21.10 mil, about 21.15 mil, about 21.20 mil, about 21.25 mil, about 21.30 mil, about 21.35 mil, about 21.40 mil, about 21.45 mil, about 21.50 mil, about 21.55 mil, about 21.60 mil, about 21.65 mil, about 21.70 mil, about 21.80 mil, about 21.85 mil, about 21.90 mil, about 22.0 mil, about 22.10 mil, about 22.15 mil, about 22.20 mil, about 22.25 mil, about 22.30 mil, about 22.35 mil, about 22.40 mil, about 22.45 mil, about 22.50 mil, about 22.55 mil, about 22.60 mil, about 22.65 mil, about 22.70 mil, about 22.80 mil, about 22.85 mil, about 22.90 mil, about 23.0 mil, about 23.10 mil, about 23.15 mil, about 23.20 mil, about 23.25 mil, about 23.30 mil, about 23.35 mil, about 23.40 mil, about 23.45 mil, about 23.50 mil, about 23.55 mil, about 23.60 mil, about 23.65 mil, about 23.70 mil, about 23.80 mil, about 23.85 mil, about 23.90 mil, about 24.0 mil. It is understood that recitation of the above discrete values includes a range between each recited value. It is understood that recitation of the above ranges includes a discrete values between each recited range. A mil is one thousandth of an inch (0.001″).

As another example, the laminate material can have a thickness of between about 1 mil and 125 mil. For example, the laminate film thickness can be about 1 mil, about 2 mil, about 3 mil, about 4 mil, about 5 mil, about 6 mil, about 7 mil, about 8 mil, about 9 mil, about 10 mil, 11 mil, about 12 mil, about 13 mil, about 14 mil, about 15 mil, about 16 mil, about 17 mil, about 18 mil, about 19 mil, about 20 mil, 21 mil, about 22 mil, about 23 mil, about 24 mil, about 25 mil, about 26 mil, about 27 mil, about 28 mil, about 29 mil, about 30 mil, 31 mil, about 32 mil, about 33 mil, about 34 mil, about 35 mil, about 36 mil, about 37 mil, about 38 mil, about 39 mil, about 40 mil, 41 mil, about 42 mil, about 43 mil, about 44 mil, about 45 mil, about 46 mil, about 47 mil, about 48 mil, about 49 mil, about 50 mil, 51 mil, about 52 mil, about 53 mil, about 54 mil, about 55 mil, about 56 mil, about 57 mil, about 58 mil, about 59 mil, about 60 mil, 61 mil, about 62 mil, about 63 mil, about 64 mil, about 65 mil, about 66 mil, about 67 mil, about 68 mil, about 69 mil, about 70 mil, 71 mil, about 72 mil, about 73 mil, about 74 mil, about 75 mil, about 76 mil, about 77 mil, about 78 mil, about 79 mil, about 80 mil, 81 mil, about 82 mil, about 83 mil, about 84 mil, about 85 mil, about 86 mil, about 87 mil, about 88 mil, about 89 mil, about 90 mil, 91 mil, about 92 mil, about 93 mil, about 94 mil, about 95 mil, about 96 mil, about 97 mil, about 98 mil, about 99 mil, about 100 mil, 101 mil, about 102 mil, about 103 mil, about 104 mil, about 105 mil, about 106 mil, about 107 mil, about 108 mil, about 109 mil, about 110 mil, 111 mil, about 112 mil, about 113 mil, about 114 mil, about 115 mil, about 116 mil, about 117 mil, about 118 mil, about 119 mil, about 120 mil, 121 mil, about 122 mil, about 123 mil, about 124 mil, or about 125 mil. It is understood that recitation of the above discrete values includes a range between each recited value. It is understood that recitation of the above ranges includes a discrete values between each recited range. A mil is one thousandth of an inch (0.001″).

The core size of a laminate film material can have a core diameter of between about 1 inch and about 3 inches, For example, laminate film material can have a core diameter of 2¼ in.

### Laminating Methods

Methods of laminating materials are well known in the art. A material (e.g., sheet metal) can be laminated, for example, by use of heat, pressure, welding, or adhesives. Different lamination processes can be used depending on the type of materials to be laminated.

Lamination of materials can be achieved with roll laminators. Roll laminators can use one or two rolls of lamination material to complete the lamination process, with one roll being on top and, optionally, another roll on the bottom. These rolls can slide onto metal bars, known as mandrels, which are then placed in the machine and feed through it.

For example, a material can be laminated with a heated roll laminator. A heated roll laminator can use heated rollers to melt adhesive (e.g., glue) extruded onto lamination material (e.g., film). The lamination material can be applied to a substrate (e.g., sheet metal) using pressure rollers. Heated roll laminators can be used to apply varying thicknesses or layers of lamination material onto substrates (e.g., sheet metal, glass, paper, fiber, wood). Heated laminators can use heated rollers or heated shoes to melt the adhesive or glue which is applied to lamination material (e.g., film). In some embodiments, the adhesive (e.g., glue) can be applied as a sheet (e.g., solid glue sheet) in between the laminate material and the substrate or layered in between layers or multiple layers of substrate or laminate materials. The process of heating the glue prior to applying the film to a substrate can allow for a faster application of the lamination material. The laminates and adhesives used in heated roll laminates are generally cheaper to manufacture than cold roll laminates, often as much as half the cost depending on the comparison made. As the adhesive materials can be non-adhesive until exposed to heat, they can be much easier to handle. The glue can be solid at room temperature, so lamination of this type can be less likely to shift or warp after its application than pressure activated laminates, which can rely on a highly viscous, adhesive fluid. The temperature of heated roll laminates can be at least 150° F. For example, the temperature range of heated roll laminates can be between about 210° F. and 275° F. As another example, the temperature of the heated roll can be between about 215° F. and 250° F. As another example, the temperature of the heated roll can be about 150° F., about 160° F., about 170° F., about 180° F., about 190° F., about 200° F., about 210° F., about 220° F., about 230° F., about 240° F., about 250° F., about 260° F., about 270° F., about 280° F., about 290° F., about 300° F., about 310° F., about 320° F., about 330° F., about 340° F., about 350° F., about 360° F., about 370° F., about 380° F., about 390° F., or about 400° F. It is understood that recitation of the above discrete values includes a range between each recited value. It is understood that recitation of the above ranges includes a discrete values between each recited range.

The laminated sheet metal may also be cooled, for example by air directed onto the roll or by water which may pass directly or in a zigzag manner through the roll.

As another example, a material can be laminated with a cold roll laminator. Cold roll laminators can use a laminate material (e.g., plastic film) which can be coated with an adhesive and, optionally, a glossy backing which does not adhere to the glue. When the glossy backing is removed, the adhesive can be exposed, which can be directly applied onto the item which needs to be laminated. This method, apart from having the obvious benefit of not requiring expensive equipment, is also suitable for those items which could be damaged by heat. Cold laminators can range from simple two roller, hand crank machines up to large and complex motor driven machines with high precision rollers, adjustable roller pressure and other advanced features.

Cold lamination increased in popularity with the rise of wide format inkjet printers, which often used inks and papers incompatible with hot lamination. A large percentage of cold laminate for use in the print industry is polyvinyl chloride (PVC), although a wide range of other materials are available. Cold laminating processes are also used outside of the print industry, for example coating sheet glass or stainless steel with protective films.

Cold roll laminators are also used for laying down adhesive films in the sign making industry, for example mounting a large print onto a board. A practiced operator can apply a large adhesive sheet in a fraction of the time it takes to do so by hand.

High-pressure laminates can be laminates manufactures (e.g., molded and cured) at pressures not lower than 1,000 lb per sq in. (70 kg per sq cm) and more commonly in the range of 1,200 to 2,000 lb per sq in. (84 to 140 kg per sq cm). For example, high-pressure laminates can be manufactured at pressures between about 1,000 lb/in² and 2,000 lb/in². As another example, high-pressure laminates can be manufactured at pressures of about 1,000 lb/in², 1,025 lb/in², about 1,050 lb/in², 1,075 lb/in², 1,100 lb/in², 1,125 lb/in², 1,150 lb/in², 1,175 lb/in², 1,200 lb/in² 1,225 lb/in², 1,250 lb/in², 1,275 lb/in², 1,300 lb/in², 1,325 lb/in², 1,350 lb/in², 1,375 lb/in² 1,400 lb/in², 1,425 lb/in², 1,450 lb/in², 1,475 lb/in², 1,500 lb/in², 1,525 lb/in², 1,550 lb/in² 1,575 lb/in², 1,600 lb/in², 1,625 lb/in², 1,650 lb/in², 1,675 lb/in², 1,700 lb/in², 1,725 lb/in² 1,750 lb/in², 1,775 lb/in², 1,800 lb/in², 1,825 lb/in², 1,850 lb/in², 1,900 lb/in², 1,925 lb/in² 1,950 lb/in², 1,975 lb/in², or 2,000 lb/in². It is understood that recitation of the above ranges includes discrete values between each recited range. It is understood that recitation of the above discrete values includes ranges between each discrete value.

Low pressure laminate can be a plastic laminate manufactured (e.g., molded and cured) at pressures, in general, of about 400 pounds per square inch (or approximately 27 atmospheres or 2.8×10⁶ Pascals). For example, low-pressure laminates can be manufactured at pressures between about 10 lb/in² and about 1,000 lb/in². As another example, low-pressure laminates can be manufactured at pressures of about 10 lb/in², about 20 lb/in², about 30 lb/in², about 40 lb/in², about 50 lb/in², about 60 lb/in², about 70 lb/in², about 80 lb/in², about 90 lb/in², about 100 lb/in², 110 lb/in², about 120 lb/in², about 130 lb/in², about 140 lb/in², about 150 lb/in², about 160 lb/in², about 170 lb/in², about 180 lb/in², about 190 lb/in², about 200 lb/in², 210 lb/in², about 220 lb/in², about 230 lb/in², about 240 lb/in², about 250 lb/in², about 260 lb/in², about 270 lb/in², about 280 lb/in², about 290 lb/in², about 300 lb/in², 310 lb/in², about 320 lb/in², about 330 lb/in², about 340 lb/in², about 350 lb/in², about 360 lb/in², about 370 lb/in², about 380 lb/in², about 390 lb/in², about 400 lb/in², 410 lb/in², about 420 lb/in², about 430 lb/in², about 440 lb/in², about 450 lb/in², about 460 lb/in², about 470 lb/in², about 480 lb/in², about 490 lb/in², about 500 lb/in², 510 lb/in², about 520 lb/in², about 530 lb/in², about 540 lb/in², about 550 lb/in², about 560 lb/in², about 570 lb/in², about 580 lb/in², about 590 lb/in², about 600 lb/in², 610 lb/in², about 620 lb/in², about 630 lb/in², about 640 lb/in², about 650 lb/in², about 660 lb/in², about 670 lb/in², about 680 lb/in², about 690 lb/in², about 700 lb/in², 710 lb/in², about 720 lb/in², about 730 lb/in², about 740 lb/in², about 750 lb/in², about 760 lb/in², about 770 lb/in², about 780 lb/in², about 790 lb/in², about 800 lb/in², 810 lb/in², about 820 lb/in², about 830 lb/in², about 840 lb/in², about 850 lb/in², about 860 lb/in², about 870 lb/in², about 880 lb/in², about 890 lb/in², about 900 lb/in², 910 lb/in², about 920 lb/in², about 930 lb/in², about 940 lb/in², about 950 lb/in², about 960 lb/in², about 970 lb/in², about 980 lb/in², about 990 lb/in², or about 1,000 lb/in². It is understood that recitation of the above ranges includes discrete values between each recited range. It is understood that recitation of the above discrete values includes ranges between each discrete value.

### Adhesive

As described herein, an adhesive can be any adhesive suitable for use in laminating a sheet metal.

As described herein, adhesive can be a gum, glue, paste, epoxy resin, sealant, seal, binder, solid adhesive, bonding agent, binding agent, sticking agent, adhering agent, tacky agent, cement, adhesive material, adhesive film, bond, sticky, adherent, fixative, stickum, adhesive strip, or adhesive tape. As described herein adhesives suitable for use in lamination can include any solid adhesive, pressure- or temperature-sensitive adhesive, spray on adhesive, or sheet adhesive. For example a heat-sensitive (hot) adhesive can include copolyamide (PA), copolyester (PES), polyurethane (TPU), ethylene (e.g., vinyl acetate copolymer (EVA)), high density polyethylene (HDPE), or ethylene (e.g., acrylic acid copolymer (EAA)).

As described herein adhesives suitable for use in lamination can include solvent based laminating adhesives, solventless laminating adhesives, water based laminating adhesives, wet bond laminating adhesives, high pressure laminating adhesives, insulation laminating adhesives, paper converting laminating adhesives, or wood laminating adhesives. For example, adhesives can comprise, Adhesin 3738T Bonding Adhesive, Adhesin 3781 Bonding Adhesive, Adhesin 55-5005, Adhesin 55-6007M, Adhesin 56-0004UV, Adhesin Vetak 7709T Green, Adhesin Vetak 7747, AQUENCE 034-088-050 (5093) (Known as Adhesin 51-3093), AQUENCE 034-088-223 (7348H) (Known as Adhesin 45-7348H), AQUENCE AV 5531 (Known as Adhesin 56-5531), AQUENCE AV 7584 BLACK (Known as Adhesin)(A-7584 Black), AQUENCE AV 7597 (Known as Adhesin XA-7597LV), AQUENCE AV 7597 (Known as Adhesin XA-7597), AQUENCE AV 797 (Known as Adhesin Vetak V797), AQUENCE CATALYST R 396 (Known as Dorus R 396), AQUENCE CG 3130 (Known as Adhesin 51-3130), AQUENCE ENV 6135HUV VECTORPATCH (Known as Adhesin 56-6135HUV), AQUENCE LA 208A (Known as Adhesin Ultimate Control 32-208A), AQUENCE PL 1913 (Known as DORUS WL 1913), AQUENCE WL 5704 (Known as Adhesin Vetak LAW 5704), Dorus 51-5659UV, Dorus 56-3173M, LOCTITE EA 9390 AERO (Known as HYSOL EA 9390 GAL SYSTEM), LOCTITE LIOFOL LA 7773-21 (Known as Liofol LA7773-21), Purmelt R-200 UV, Purmelt R-200F+, or Terostat MS 642.

As described herein, an adhesive suitable for lamination can include a webbed, stranded, or mesh glue comprising thermoplastic adhesive polymer. Thermoplastic polymer adhesive can be heat-sealing, adhesive webs (Spunfab) available in a wide range of polymer formulations, basis weights, and roll widths, and can be developed to meet special requirements, or to meet particular industry codes and specifications are available in a wide range of polymer formulations, basis weights, and roll widths, and can be developed to meet special requirements, or to meet particular industry codes and specifications. For example, a thermoplastic adhesive polymer can include an adhesive web. The polymer can comprise CoPolyamide, CoPolyester, Polyolefins, Ternary, Polypropylene, or Polyurethane. Thermoplastic adhesive polymers, as described herein can be activated by pressure, heat (thermal), RF or HF frequency, or Ultrasound.

As described herein, the materials and methods as described herein can comprise an adhesive suitable for use in laminating materials suitable for HVAC purposes or applications. For example, an adhesive material suitable for HVAC purposes or applications can pass certain standards, for example, UL181 (flame penetration test) and UL723 (test for surface burning characteristics of building materials).

As described herein, an adhesive can have various thicknesses. As described herein, the adhesive can be at least about 0.1 mil (or 0.0001 in). For example, an adhesive can have a thickness between about 0.0001 inches and 0.125 inches. As another example, an adhesive can have a thickness between about 0.0001 inches and 0.02 inches or between about 0.1 mil and about 20 mil. One mil is one thousandth of an inch (0.001″). For example, an adhesive, as described herein, can have a thickness between 1 mil and about 2 mil. As another example, an adhesive, as described herein can have a thickness of about 0.10 mil, about 0.15 mil, about 0.20 mil, about 0.25 mil, about 0.30 mil, about 0.35 mil, about 0.40 mil, about 0.45 mil, about 0.50 mil, about 0.55 mil, about 0.60 mil, about 0.65 mil, about 0.70 mil, about 0.80 mil, about 0.85 mil, about 0.90 mil, about 1.0 mil, about 1.10 mil, about 1.15 mil, about 1.20 mil, about 1.25 mil, about 1.30 mil, about 1.35 mil, about 1.40 mil, about 1.45 mil, about 1.50 mil, about 1.55 mil, about 1.60 mil, about 1.65 mil, about 1.70 mil, about 1.80 mil, about 1.85 mil, about 1.90 mil, about 2.0 mil, about 2.10 mil, about 2.15 mil, about 2.20 mil, about 2.25 mil, about 2.30 mil, about 2.35 mil, about 2.40 mil, about 2.45 mil, about 2.50 mil, about 2.55 mil, about 2.60 mil, about 2.65 mil, about 2.70 mil, about 2.80 mil, about 2.85 mil, about 2.90 mil, about 3.0 mil, about 3.10 mil, about 3.15 mil, about 3.20 mil, about 3.25 mil, about 3.30 mil, about 3.35 mil, about 3.40 mil, about 3.45 mil, about 3.50 mil, about 3.55 mil, about 3.60 mil, about 3.65 mil, about 3.70 mil, about 3.80 mil, about 3.85 mil, about 3.90 mil, about 4.0 mil, about 4.10 mil, about 4.15 mil, about 4.20 mil, about 4.25 mil, about 4.30 mil, about 4.35 mil, about 4.40 mil, about 4.45 mil, about 4.50 mil, about 4.55 mil, about 4.60 mil, about 4.65 mil, about 4.70 mil, about 4.80 mil, about 4.85 mil, about 4.90 mil, about 5.0 mil, about 5.10 mil, about 5.15 mil, about 5.20 mil, about 5.25 mil, about 5.30 mil, about 5.35 mil, about 5.40 mil, about 5.45 mil, about 5.50 mil, about 5.55 mil, about 5.60 mil, about 5.65 mil, about 5.70 mil, about 5.80 mil, about 5.85 mil, about 5.90 mil, about 6.0 mil, about 6.10 mil, about 6.15 mil, about 6.20 mil, about 6.25 mil, about 6.30 mil, about 6.35 mil, about 6.40 mil, about 6.45 mil, about 6.50 mil, about 6.55 mil, about 6.60 mil, about 6.65 mil, about 6.70 mil, about 6.80 mil, about 6.85 mil, about 6.90 mil, about 7.0 mil, about 7.10 mil, about 7.15 mil, about 7.20 mil, about 7.25 mil, about 7.30 mil, about 7.35 mil, about 7.40 mil, about 7.45 mil, about 7.50 mil, about 7.55 mil, about 7.60 mil, about 7.65 mil, about 7.70 mil, about 7.80 mil, about 7.85 mil, about 7.90 mil, about 8.0 mil, about 8.10 mil, about 8.15 mil, about 8.20 mil, about 8.25 mil, about 8.30 mil, about 8.35 mil, about 8.40 mil, about 8.45 mil, about 8.50 mil, about 8.55 mil, about 8.60 mil, about 8.65 mil, about 8.70 mil, about 8.80 mil, about 8.85 mil, about 8.90 mil, about 9.0 mil, about 9.10 mil, about 9.15 mil, about 9.20 mil, about 9.25 mil, about 9.30 mil, about 9.35 mil, about 9.40 mil, about 9.45 mil, about 9.50 mil, about 9.55 mil, about 9.60 mil, about 9.65 mil, about 9.70 mil, about 9.80 mil, about 9.85 mil, about 9.90 mil, about 10.0 mil, about 10.10 mil, about 10.15 mil, about 10.20 mil, about 10.25 mil, about 10.30 mil, about 10.35 mil, about 10.40 mil, about 10.45 mil, about 10.50 mil, about 10.55 mil, about 10.60 mil, about 10.65 mil, about 10.70 mil, about 10.80 mil, about 10.85 mil, about 10.90 mil, about 11.0 mil, about 11.10 mil, about 11.15 mil, about 11.20 mil, about 11.25 mil, about 11.30 mil, about 11.35 mil, about 11.40 mil, about 11.45 mil, about 11.50 mil, about 11.55 mil, about 11.60 mil, about 11.65 mil, about 11.70 mil, about 11.80 mil, about 11.85 mil, about 11.90 mil, about 12.0 mil, about 12.10 mil, about 12.15 mil, about 12.20 mil, about 12.25 mil, about 12.30 mil, about 12.35 mil, about 12.40 mil, about 12.45 mil, about 12.50 mil, about 12.55 mil, about 12.60 mil, about 12.65 mil, about 12.70 mil, about 12.80 mil, about 12.85 mil, about 12.90 mil, about 13.0 mil, about 13.10 mil, about 13.15 mil, about 13.20 mil, about 13.25 mil, about 13.30 mil, about 13.35 mil, about 13.40 mil, about 13.45 mil, about 13.50 mil, about 13.55 mil, about 13.60 mil, about 13.65 mil, about 13.70 mil, about 13.80 mil, about 13.85 mil, about 13.90 mil, about 14.0 mil, about 14.10 mil, about 14.15 mil, about 14.20 mil, about 14.25 mil, about 14.30 mil, about 14.35 mil, about 14.40 mil, about 14.45 mil, about 14.50 mil, about 14.55 mil, about 14.60 mil, about 14.65 mil, about 14.70 mil, about 14.80 mil, about 14.85 mil, about 14.90 mil, about 15.0 mil, about 15.10 mil, about 15.15 mil, about 15.20 mil, about 15.25 mil, about 15.30 mil, about 15.35 mil, about 15.40 mil, about 15.45 mil, about 15.50 mil, about 15.55 mil, about 15.60 mil, about 15.65 mil, about 15.70 mil, about 15.80 mil, about 15.85 mil, about 15.90 mil, about 16.0 mil, about 16.10 mil, about 16.15 mil, about 16.20 mil, about 16.25 mil, about 16.30 mil, about 16.35 mil, about 16.40 mil, about 16.45 mil, about 16.50 mil, about 16.55 mil, about 16.60 mil, about 16.65 mil, about 16.70 mil, about 16.80 mil, about 16.85 mil, about 16.90 mil, about 17.0 mil, about 17.10 mil, about 17.15 mil, about 17.20 mil, about 17.25 mil, about 17.30 mil, about 17.35 mil, about 17.40 mil, about 17.45 mil, about 17.50 mil, about 17.55 mil, about 17.60 mil, about 17.65 mil, about 17.70 mil, about 17.80 mil, about 17.85 mil, about 17.90 mil, about 18.0 mil, about 18.10 mil, about 18.15 mil, about 18.20 mil, about 18.25 mil, about 18.30 mil, about 18.35 mil, about 18.40 mil, about 18.45 mil, about 18.50 mil, about 18.55 mil, about 18.60 mil, about 18.65 mil, about 18.70 mil, about 18.80 mil, about 18.85 mil, about 18.90 mil, about 19.0 mil, about 19.10 mil, about 19.15 mil, about 19.20 mil, about 19.25 mil, about 19.30 mil, about 19.35 mil, about 19.40 mil, about 19.45 mil, about 19.50 mil, about 19.55 mil, about 19.60 mil, about 19.65 mil, about 19.70 mil, about 19.80 mil, about 19.85 mil, about 19.90 mil, about 20.0 mil, about 20.10 mil, about 20.15 mil, about 20.20 mil, about 20.25 mil, about 20.30 mil, about 20.35 mil, about 20.40 mil, about 20.45 mil, about 20.50 mil, about 20.55 mil, about 20.60 mil, about 20.65 mil, about 20.70 mil, about 20.80 mil, about 20.85 mil, about 20.90 mil, about 21.0 mil, about 21.10 mil, about 21.15 mil, about 21.20 mil, about 21.25 mil, about 21.30 mil, about 21.35 mil, about 21.40 mil, about 21.45 mil, about 21.50 mil, about 21.55 mil, about 21.60 mil, about 21.65 mil, about 21.70 mil, about 21.80 mil, about 21.85 mil, about 21.90 mil, about 22.0 mil, about 22.10 mil, about 22.15 mil, about 22.20 mil, about 22.25 mil, about 22.30 mil, about 22.35 mil, about 22.40 mil, about 22.45 mil, about 22.50 mil, about 22.55 mil, about 22.60 mil, about 22.65 mil, about 22.70 mil, about 22.80 mil, about 22.85 mil, about 22.90 mil, about 23.0 mil, about 23.10 mil, about 23.15 mil, about 23.20 mil, about 23.25 mil, about 23.30 mil, about 23.35 mil, about 23.40 mil, about 23.45 mil, about 23.50 mil, about 23.55 mil, about 23.60 mil, about 23.65 mil, about 23.70 mil, about 23.80 mil, about 23.85 mil, about 23.90 mil, or about 24.0 mil. It is understood that recitation of the above discrete values includes a range between each recited value. It is understood that recitation of the above ranges includes a discrete values between each recited range.

### Sheet Metal

Sheet metal, as disclosed herein, can be a substrate material comprising a metal suitable for lamination. For example, sheet metal can comprise any metal, any combinations of metal, any metal composite/alloy, or any metallic material or material comprising metal that can be processed into a sheet, foil, layer, or film. A substrate as described herein can be a flexible sheet metal.

As described herein, sheet metal can be formed by an industrial process into thin, flat pieces. It is one of the fundamental forms used in metalworking and it can be cut and bent into a variety of shapes.

As described herein, a sheet metal can be any material comprising metal suitable for use in building materials or HVAC applications. As an example, sheet metal can have antimicrobial characteristics suitable for use in clean rooms and hospitals. As another example, copper can be used as a metal shown to have antimicrobial properties.

### Characteristics of Sheet Metal

As described herein, sheet metal can be of varying weights and thicknesses. For example, a sheet metal can be of any thickness such that the sheet metal is flexible. Sheet metal thickness can vary significantly depending on the composition. Some extremely thin thicknesses of sheet metal can be considered foil or leaf, and some sheet metal thicker than 6 mm (0.25 in) can be considered plate, depending on the composition of the sheet metal. As such, sheet metal as described herein can be from between about 0.0001 inches to about 0.25 inches.

The thickness of sheet metal can be commonly specified by a traditional, non-linear measure known as its gauge. The larger the gauge number, the thinner the metal. Steel sheet metal can range from 30 gauge to about 7 gauge. Gauge can differ between ferrous (iron based) metals and nonferrous metals such as aluminum or copper. For example, copper thickness, can be measured in ounces (and represents the thickness of 1 ounce of copper rolled out to an area of 1 square foot). Other than the U.S., sheet metal thickness is measured in millimeters.

Sheet metal, as described herein can be between 30 gauge and 3 gauge, although higher or lower bounds are possible. For example, the sheet metal can have a thickness of about 30 gauge, about 29 gauge, about 28 gauge, about 27 gauge, about 26 gauge, about 25 gauge, about 24 gauge, about 23 gauge, about 22 gauge, about 21 gauge, about 20 gauge, about 19 gauge, 18 gauge, about 17 gauge, about 16 gauge, about 15 gauge, about 14 gauge, about 13 gauge, about 12 gauge, about 11 gauge, about 10 gauge, about 9 gauge, 8 gauge, about 7 gauge, about 6 gauge, about 5 gauge, about 4 gauge, or about 3 gauge.

TABLE 1
Reference to gauges of material, pounds per square foot, and gauge decimal
equivalents.

| | | | Galvanized | | | | | |
|---|---|---|---|---|---|---|---|---|
| | Sheet Steel | | Steel | | Stainless Steel | | Aluminum | |
| | Gauge | Lbs. per | Gauge | Lbs. per | Gauge | Lbs. per | Gauge | Lbs. per |
| Gauge | Decimal | Sq. Ft. | Decimal | Sq. Ft. | Decimal | Sq. Ft. | Decimal | Sq. Ft. |
| 30 | 0.0120 | 0.500 | 0.016 | 0.656 | | | 0.0100 | 0.141 |
| 29 | 0.0135 | 0.563 | 0.017 | 0.719 | | | 0.0113 | 0.160 |
| 28 | 0.0149 | 0.625 | 0.019 | 0.781 | | | 0.0126 | 0.178 |
| 27 | 0.0164 | 0.688 | 0.020 | 0.844 | | | 0.0142 | 0.200 |
| 26 | 0.0179 | 0.750 | 0.022 | 0.906 | 0.018 | 0.756 | 0.0159 | 0.224 |
| 25 | 0.0209 | 0.875 | 0.025 | 1.031 | | | 0.0179 | 0.253 |
| 24 | 0.0239 | 1.000 | 0.028 | 1.156 | 0.024 | 1.008 | 0.0201 | 0.284 |
| 23 | 0.0269 | 1.125 | 0.031 | 1.281 | | | 0.0226 | 0.319 |
| 22 | 0.0299 | 1.250 | 0.034 | 1.406 | 0.03 | 1.26 | 0.0253 | 0.357 |
| 21 | 0.0329 | 1.375 | 0.037 | 1.531 | | | 0.0285 | 0.402 |
| 20 | 0.0359 | 1.500 | 0.040 | 1.656 | 0.036 | 1.512 | 0.0320 | 0.452 |
| 19 | 0.0418 | 1.750 | 0.046 | 1.906 | | | 0.0359 | 0.507 |
| 18 | 0.0478 | 2.000 | 0.052 | 2.156 | 0.048 | 2.016 | 0.0403 | 0.569 |
| 17 | 0.0538 | 2.250 | 0.058 | 2.406 | | | 0.0453 | 0.639 |
| 16 | 0.0598 | 2.500 | 0.064 | 2.656 | 0.06 | 2.52 | 0.0508 | 0.717 |
| 15 | 0.0673 | 2.813 | 0.071 | 2.969 | | | 0.0571 | 0.806 |
| 14 | 0.0747 | 3.125 | 0.079 | 3.281 | 0.075 | 3.15 | 0.0641 | 0.905 |
| 13 | 0.0897 | 3.750 | 0.093 | 3.906 | | | 0.0720 | 1.016 |
| 12 | 0.1046 | 4.375 | 0.108 | 4.531 | 0.105 | 4.41 | 0.8080 | 1.140 |
| 11 | 0.1196 | 5.000 | 0.123 | 5.156 | 0.12 | 5.04 | 0.0907 | 1.280 |
| 10 | 0.1345 | 5.625 | 0.138 | 5.781 | 0.135 | 5.67 | 0.1019 | 1.438 |
| 9 | 0.1495 | 6.250 | 0.153 | 6.406 | | | 0.1144 | 1.614 |
| 8 | 0.1644 | 6.875 | 0.168 | 7.031 | 0.165 | 6.93 | 0.1285 | 1.813 |
| 7 | 0.1793 | 7.500 | | | 0.1874 | 7.871 | 0.1443 | 2.036 |
| 6 | 0.1943 | 8.125 | | | | | 0.1620 | 2.286 |
| 5 | 0.2092 | 8.750 | | | | | | |
| 4 | 0.2242 | 9.375 | | | | | | |
| 3 | 0.2391 | 10.00 | | | | | | |

As described herein, sheet metal can have various thicknesses. As described herein, the sheet metal can be at least about 0.1 mil (or 0.0001 in). For example, a sheet metal can have a thickness between about 0.0001 inches and 0.125 inches. As another example, a sheet metal can have a thickness between about 0.0001 inches and 0.02 inches or between about 0.1 mil and about 20 mil. One mil is one thousandth of an inch (0.001″). For example, sheet metal, as described herein, can have a thickness between 1 mil and about 2 mil. As another example, sheet metal, as described herein have a thickness of about 0.10 mil, about 0.15 mil, about 0.20 mil, about 0.25 mil, about 0.30 mil, about 0.35 mil, about 0.40 mil, about 0.45 mil, about 0.50 mil, about 0.55 mil, about 0.60 mil, about 0.65 mil, about 0.70 mil, about 0.80 mil, about 0.85 mil, about 0.90 mil, about 1.0 mil, about 1.10 mil, about 1.15 mil, about 1.20 mil, about 1.25 mil, about 1.30 mil, about 1.35 mil, about 1.40 mil, about 1.45 mil, about 1.50 mil, about 1.55 mil, about 1.60 mil, about 1.65 mil, about 1.70 mil, about 1.80 mil, about 1.85 mil, about 1.90 mil, about 2.0 mil, about 2.10 mil, about 2.15 mil, about 2.20 mil, about 2.25 mil, about 2.30 mil, about 2.35 mil, about 2.40 mil, about 2.45 mil, about 2.50 mil, about 2.55 mil, about 2.60 mil, about 2.65 mil, about 2.70 mil, about 2.80 mil, about 2.85 mil, about 2.90 mil, about 3.0 mil, about 3.10 mil, about 3.15 mil, about 3.20 mil, about 3.25 mil, about 3.30 mil, about 3.35 mil, about 3.40 mil, about 3.45 mil, about 3.50 mil, about 3.55 mil, about 3.60 mil, about 3.65 mil, about 3.70 mil, about 3.80 mil, about 3.85 mil, about 3.90 mil, about 4.0 mil, about 4.10 mil, about 4.15 mil, about 4.20 mil, about 4.25 mil, about 4.30 mil, about 4.35 mil, about 4.40 mil, about 4.45 mil, about 4.50 mil, about 4.55 mil, about 4.60 mil, about 4.65 mil, about 4.70 mil, about 4.80 mil, about 4.85 mil, about 4.90 mil, about 5.0 mil, about 5.10 mil, about 5.15 mil, about 5.20 mil, about 5.25 mil, about 5.30 mil, about 5.35 mil, about 5.40 mil, about 5.45 mil, about 5.50 mil, about 5.55 mil, about 5.60 mil, about 5.65 mil, about 5.70 mil, about 5.80 mil, about 5.85 mil, about 5.90 mil, about 6.0 mil, about 6.10 mil, about 6.15 mil, about 6.20 mil, about 6.25 mil, about 6.30 mil, about 6.35 mil, about 6.40 mil, about 6.45 mil, about 6.50 mil, about 6.55 mil, about 6.60 mil, about 6.65 mil, about 6.70 mil, about 6.80 mil, about 6.85 mil, about 6.90 mil, about 7.0 mil, about 7.10 mil, about 7.15 mil, about 7.20 mil, about 7.25 mil, about 7.30 mil, about 7.35 mil, about 7.40 mil, about 7.45 mil, about 7.50 mil, about 7.55 mil, about 7.60 mil, about 7.65 mil, about 7.70 mil, about 7.80 mil, about 7.85 mil, about 7.90 mil, about 8.0 mil, about 8.10 mil, about 8.15 mil, about 8.20 mil, about 8.25 mil, about 8.30 mil, about 8.35 mil, about 8.40 mil, about 8.45 mil, about 8.50 mil, about 8.55 mil, about 8.60 mil, about 8.65 mil, about 8.70 mil, about 8.80 mil, about 8.85 mil, about 8.90 mil, about 9.0 mil, about 9.10 mil, about 9.15 mil, about 9.20 mil, about 9.25 mil, about 9.30 mil, about 9.35 mil, about 9.40 mil, about 9.45 mil, about 9.50 mil, about 9.55 mil, about 9.60 mil, about 9.65 mil, about 9.70 mil, about 9.80 mil, about 9.85 mil, about 9.90 mil, about 10.0 mil, about 10.10 mil, about 10.15 mil, about 10.20 mil, about 10.25 mil, about 10.30 mil, about 10.35 mil, about 10.40 mil, about 10.45 mil, about 10.50 mil, about 10.55 mil, about 10.60 mil, about 10.65 mil, about 10.70 mil, about 10.80 mil, about 10.85 mil, about 10.90 mil, about 11.0 mil, about 11.10 mil, about 11.15 mil, about 11.20 mil, about 11.25 mil, about 11.30 mil, about 11.35 mil, about 11.40 mil, about 11.45 mil, about 11.50 mil, about 11.55 mil, about 11.60 mil, about 11.65 mil, about 11.70 mil, about 11.80 mil, about 11.85 mil, about 11.90 mil, about 12.0 mil, about 12.10 mil, about 12.15 mil, about 12.20 mil, about 12.25 mil, about 12.30 mil, about 12.35 mil, about 12.40 mil, about 12.45 mil, about 12.50 mil, about 12.55 mil, about 12.60 mil, about 12.65 mil, about 12.70 mil, about 12.80 mil, about 12.85 mil, about 12.90 mil, about 13.0 mil, about 13.10 mil, about 13.15 mil, about 13.20 mil, about 13.25 mil, about 13.30 mil, about 13.35 mil, about 13.40 mil, about 13.45 mil, about 13.50 mil, about 13.55 mil, about 13.60 mil, about 13.65 mil, about 13.70 mil, about 13.80 mil, about 13.85 mil, about 13.90 mil, about 14.0 mil, about 14.10 mil, about 14.15 mil, about 14.20 mil, about 14.25 mil, about 14.30 mil, about 14.35 mil, about 14.40 mil, about 14.45 mil, about 14.50 mil, about 14.55 mil, about 14.60 mil, about 14.65 mil, about 14.70 mil, about 14.80 mil, about 14.85 mil, about 14.90 mil, about 15.0 mil, about 15.10 mil, about 15.15 mil, about 15.20 mil, about 15.25 mil, about 15.30 mil, about 15.35 mil, about 15.40 mil, about 15.45 mil, about 15.50 mil, about 15.55 mil, about 15.60 mil, about 15.65 mil, about 15.70 mil, about 15.80 mil, about 15.85 mil, about 15.90 mil, about 16.0 mil, about 16.10 mil, about 16.15 mil, about 16.20 mil, about 16.25 mil, about 16.30 mil, about 16.35 mil, about 16.40 mil, about 16.45 mil, about 16.50 mil, about 16.55 mil, about 16.60 mil, about 16.65 mil, about 16.70 mil, about 16.80 mil, about 16.85 mil, about 16.90 mil, about 17.0 mil, about 17.10 mil, about 17.15 mil, about 17.20 mil, about 17.25 mil, about 17.30 mil, about 17.35 mil, about 17.40 mil, about 17.45 mil, about 17.50 mil, about 17.55 mil, about 17.60 mil, about 17.65 mil, about 17.70 mil, about 17.80 mil, about 17.85 mil, about 17.90 mil, about 18.0 mil, about 18.10 mil, about 18.15 mil, about 18.20 mil, about 18.25 mil, about 18.30 mil, about 18.35 mil, about 18.40 mil, about 18.45 mil, about 18.50 mil, about 18.55 mil, about 18.60 mil, about 18.65 mil, about 18.70 mil, about 18.80 mil, about 18.85 mil, about 18.90 mil, about 19.0 mil, about 19.10 mil, about 19.15 mil, about 19.20 mil, about 19.25 mil, about 19.30 mil, about 19.35 mil, about 19.40 mil, about 19.45 mil, about 19.50 mil, about 19.55 mil, about 19.60 mil, about 19.65 mil, about 19.70 mil, about 19.80 mil, about 19.85 mil, about 19.90 mil, about 20.0 mil, about 20.10 mil, about 20.15 mil, about 20.20 mil, about 20.25 mil, about 20.30 mil, about 20.35 mil, about 20.40 mil, about 20.45 mil, about 20.50 mil, about 20.55 mil, about 20.60 mil, about 20.65 mil, about 20.70 mil, about 20.80 mil, about 20.85 mil, about 20.90 mil, about 21.0 mil, about 21.10 mil, about 21.15 mil, about 21.20 mil, about 21.25 mil, about 21.30 mil, about 21.35 mil, about 21.40 mil, about 21.45 mil, about 21.50 mil, about 21.55 mil, about 21.60 mil, about 21.65 mil, about 21.70 mil, about 21.80 mil, about 21.85 mil, about 21.90 mil, about 22.0 mil, about 22.10 mil, about 22.15 mil, about 22.20 mil, about 22.25 mil, about 22.30 mil, about 22.35 mil, about 22.40 mil, about 22.45 mil, about 22.50 mil, about 22.55 mil, about 22.60 mil, about 22.65 mil, about 22.70 mil, about 22.80 mil, about 22.85 mil, about 22.90 mil, about 23.0 mil, about 23.10 mil, about 23.15 mil, about 23.20 mil, about 23.25 mil, about 23.30 mil, about 23.35 mil, about 23.40 mil, about 23.45 mil, about 23.50 mil, about 23.55 mil, about 23.60 mil, about 23.65 mil, about 23.70 mil, about 23.80 mil, about 23.85 mil, about 23.90 mil, or about 24.0 mil. It is understood that recitation of the above discrete values includes a range between each recited value. It is understood that recitation of the above ranges includes a discrete values between each recited range.

As another example, the sheet metal can have a thickness of between about 1 mil and 125 mil. For example, the sheet metal thickness can be about 1 mil, about 2 mil, about 3 mil, about 4 mil, about 5 mil, about 6 mil, about 7 mil, about 8 mil, about 9 mil, about 10 mil, 11 mil, about 12 mil, about 13 mil, about 14 mil, about 15 mil, about 16 mil, about 17 mil, about 18 mil, about 19 mil, about 20 mil, 21 mil, about 22 mil, about 23 mil, about 24 mil, about 25 mil, about 26 mil, about 27 mil, about 28 mil, about 29 mil, about 30 mil, 31 mil, about 32 mil, about 33 mil, about 34 mil, about 35 mil, about 36 mil, about 37 mil, about 38 mil, about 39 mil, about 40 mil, 41 mil, about 42 mil, about 43 mil, about 44 mil, about 45 mil, about 46 mil, about 47 mil, about 48 mil, about 49 mil, about 50 mil, 51 mil, about 52 mil, about 53 mil, about 54 mil, about 55 mil, about 56 mil, about 57 mil, about 58 mil, about 59 mil, about 60 mil, 61 mil, about 62 mil, about 63 mil, about 64 mil, about 65 mil, about 66 mil, about 67 mil, about 68 mil, about 69 mil, about 70 mil, 71 mil, about 72 mil, about 73 mil, about 74 mil, about 75 mil, about 76 mil, about 77 mil, about 78 mil, about 79 mil, about 80 mil, 81 mil, about 82 mil, about 83 mil, about 84 mil, about 85 mil, about 86 mil, about 87 mil, about 88 mil, about 89 mil, about 90 mil, 91 mil, about 92 mil, about 93 mil, about 94 mil, about 95 mil, about 96 mil, about 97 mil, about 98 mil, about 99 mil, about 100 mil, 101 mil, about 102 mil, about 103 mil, about 104 mil, about 105 mil, about 106 mil, about 107 mil, about 108 mil, about 109 mil, about 110 mil, 111 mil, about 112 mil, about 113 mil, about 114 mil, about 115 mil, about 116 mil, about 117 mil, about 118 mil, about 119 mil, about 120 mil, 121 mil, about 122 mil, about 123 mil, about 124 mil, or about 125 mil. It is understood that recitation of the above discrete values includes a range between each recited value. It is understood that recitation of the above ranges includes a discrete values between each recited range. A mil is one thousandth of an inch (0.001″).

As described herein, sheet metal can be of various weights. As described herein, sheet metal can weigh between about 0.1 lbs/ft² and 10 lbs/ft². For example, the sheet metal can weigh about 0.1 lbs/ft², about 0.2 lbs/ft², about 0.3 lbs/ft², about 0.4 lbs/ft², about 0.5 lbs/ft², about 0.6 lbs/ft², about 0.7 lbs/ft², about 0.8 lbs/ft², about 0.9 lbs/ft², about 1.0 lbs/ft², 1.1 lbs/ft², about 1.2 lbs/ft², about 1.3 lbs/ft², about 1.4 lbs/ft², about 1.5 lbs/ft², about 1.6 lbs/ft², about 1.7 lbs/ft², about 1.8 lbs/ft², about 1.9 lbs/ft², about 2.0 lbs/ft², 2.1 lbs/ft², about 2.2 lbs/ft², about 2.3 lbs/ft², about 2.4 lbs/ft², about 2.5 lbs/ft², about 2.6 lbs/ft², about 2.7 lbs/ft², about 2.8 lbs/ft², about 2.9 lbs/ft², about 3.0 lbs/ft², 3.1 lbs/ft², about 3.2 lbs/ft², about 3.3 lbs/ft², about 3.4 lbs/ft², about 3.5 lbs/ft², about 3.6 lbs/ft², about 3.7 lbs/ft², about 3.8 lbs/ft², about 3.9 lbs/ft², about 4.0 lbs/ft², 4.1 lbs/ft², about 4.2 lbs/ft², about 4.3 lbs/ft², about 4.4 lbs/ft², about 4.5 lbs/ft², about 4.6 lbs/ft², about 4.7 lbs/ft², about 4.8 lbs/ft², about 4.9 lbs/ft², about 5.0 lbs/ft², 6.1 lbs/ft², about 6.2 lbs/ft², about 6.3 lbs/ft², about 6.4 lbs/ft², about 6.5 lbs/ft², about 6.6 lbs/ft², about 6.7 lbs/ft², about 6.8 lbs/ft², about 6.9 lbs/ft², about 7.0 lbs/ft², 7.1 lbs/ft², about 7.2 lbs/ft², about 7.3 lbs/ft², about 7.4 lbs/ft², about 7.5 lbs/ft², about 7.6 lbs/ft², about 7.7 lbs/ft², about 7.8 lbs/ft², about 7.9 lbs/ft², about 8.0 lbs/ft², 9.1 lbs/ft², about 9.2 lbs/ft², about 9.3 lbs/ft², about 9.4 lbs/ft², about 9.5 lbs/ft², about 9.6 lbs/ft², about 9.7 lbs/ft², about 9.8 lbs/ft², about 9.9 lbs/ft², or about 10.0 lbs/ft². It is understood that recitation of the above discrete values includes a range between each recited value. It is understood that recitation of the above ranges includes a discrete values between each recited range.

### Metals and Alloys

Sheet metal can comprise a metal or combination of metals and auxiliary materials. For example, sheet metal can comprise aluminum, brass, copper, steel, tin, nickel, or titanium. As another example, especially in decorative applications (e.g., ceiling/wall/floor tiles, coverings), sheet metal can comprise silver, gold, or platinum.

For example, sheet metal can comprise a metal or alloy of metal comprising aluminum, iron, copper, lead, tin, brass, bronze, stainless steel, galvanized steel, magnesium, zinc, steel, cast iron, tool steel, alloy steel, nickel, silver gold, platinum, palladium, lead, titanium, silicon, carbon, tin, brass, carbon steel, low carbon steel, chromium plated steel, chromium, nickel, molybdenum, ruthenium, rhodium, osmium, iridium, antimony, manganese, phosphorous, cobalt, mercury, cobalt, chromium, tungsten, bismuth, zinc, or cadmium.

An alloy can be a mixture of two or more elements, as described herein, in which the main component is a metal. For example, some pure metals are either too soft, brittle or chemically reactive for practical use. Combining different ratios of metals or other chemical elements as alloys modifies the properties of pure metals to produce desirable characteristics. The aim of making alloys is generally to make them less brittle, harder, resistant to corrosion, or have a more desirable color and luster.

As described herein, sheet metal can comprise the alloys of iron (steel, stainless steel, cast iron, tool steel, alloy steel). For example, sheet metal comprising iron alloyed with various proportions of carbon gives low, mid and high carbon steels, with increasing carbon levels reducing ductility and toughness. The addition of silicon can produce cast irons, while the addition of chromium, nickel, and molybdenum to carbon steels (more than 10%) can result in stainless steels.

As another example, sheet metal can comprise other metallic alloys, such as aluminum, titanium, copper, and magnesium. As another example, sheet metal can comprise copper alloys, such as bronze. As another example, sheet metal can comprise alloys of aluminum, titanium and magnesium. Sheet metals of alloys of aluminum, titanium and magnesium are valued for their high strength-to-weight ratios. Furthermore, magnesium can also provide electromagnetic shielding.

Alloys of aluminum can include: β-Al—Mg, ξ′-Al₃Mn, AA-8000: used for electrical building wire in the U.S. per the National Electrical Code, replacing AA-1350, Al—Li (lithium), Alnico (nickel, cobalt): Duralumin (copper), Hiduminium or R.R. alloys (2% copper, iron, nickel): used in aircraft pistons, Kryron, Magnalium (5% magnesium): used in airplane bodies, ladders, etc., Nambé (aluminum plus seven other undisclosed metals), serveware, Scandium-aluminum (scandium), or Y alloy (4% copper, nickel, magnesium). Alloys of bismuth can include Cerrosafe (lead, tin, cadmium), Rose metal (lead, tin), or Wood's metal (lead, tin, cadmium). Alloys of chromium can include Chromium hydride (hydrogen) or Nichrome (nickel). Alloys of cobalt can include Megallium, Stellite (chromium, tungsten, carbon), Talonite, Ultimet (chromium, amal, molybdenum, cyriac, tungsten), Vitallium (e.g., cobalt-chromium). Alloys of copper can include Arsenical copper, Beryllium copper (beryllium), Billon (silver), Brass (zinc), Calamine brass (zinc), Chinese silver (zinc), Dutch metal (zinc), Gilding metal (zinc), Muntz metal (zinc), Pinchbeck (zinc), Prince's metal (zinc), Tombac (zinc), Bronze (tin, aluminum or other element), Aluminium bronze (aluminum), Arsenical bronze, Bell metal (tin), Florentine bronze (aluminum or tin), Glucydur (beryllium, iron), Guanin, Gunmetal (tin, zinc), Phosphor bronze (tin and phosphorus), Ormolu (Gilt Bronze) (zinc), Speculum metal (tin), Constantan (nickel), Copper hydride (hydrogen), Copper-tungsten (tungsten), Corinthian bronze (gold, silver), Cunife (nickel, iron), Cupronickel (nickel), Cymbal alloys (Bell metal) (tin), Devarda's alloy (aluminum, zinc), Electrum (gold, silver), Hepatizon (gold, silver), Heusler alloy (manganese, tin), Manganin (manganese, nickel), Molybdochalkos (lead), Nickel silver (nickel), Nordic gold (aluminum, zinc, tin), Shakudo (gold), or Tumbaga. (gold). Alloys of gallium can include, Al Ga (aluminum, gallium), Galfenol (iron), or Galinstan (indium, tin). Alloys of gold can include Colored gold (silver, copper), Crown gold (silver, copper), Electrum (silver, copper), Rhodite (rhodium), Rose gold (copper), Tumbaga (copper), White gold (nickel, palladium), Alloys of indium can include Field's metal (bismuth, tin), Alloys of iron can include ferrous alloys, Elinvar (nickel, chromium), Fernico (nickel, cobalt), Ferroalloys (Category: Ferroalloys), Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, Ferrovanadium, Invar (nickel), Cast iron (carbon), Pig iron (carbon), Iron hydride (hydrogen), Kovar (nickel, cobalt), Spiegeleisen (manganese, carbon, silicon), or Staballoy (stainless steel) (managanese, chromium, carbon). Alloys of uranium can include Steel (carbon), Bulat steel, Chromoly (chromium, molybdenum), Crucible steel, Damascus steel, Hadfield steel, High speed steel, Mushet steel, HSLA steel, Maraging steel, Reynolds 531, Silicon steel (silicon), Spring steel, Stainless steel (chromium, nickel), AL-6XN, Alloy 20, Celestrium, Marine grade stainless, Martensitic stainless steel, Alloy 28 or Sanicro 28 (nickel, chromium), Surgical stainless steel (chromium, molybdenum, nickel), Zeron 100 (chromium, nickel, molybdenum), Tool steel (tungsten or manganese), Silver steel (US:Drill rod) (manganese, chromium, silicon), Weathering steel (‘Cor-ten’) (silicon, manganese, chromium, copper, vanadium, nickel), or Wootz steel. Alloys of lead can include Molybdochalkos (copper), Solder (tin), Terne (tin), or Type metal (tin, antimony). Alloys of magnesium can include Elektron, Magnox (aluminum), or T-Mg—Al—Zn (Bergman phase) (a complex metallic alloy). Alloys of mercury can include Amalgam. Alloys of nickel can include, Nickel alloys, Alnico (aluminum, cobalt; used in magnets), Alumel (manganese, aluminum, silicon), Chromel (chromium), Cupronickel (bronze, copper), Ferronickel (iron), German silver (copper, zinc), Hastelloy (molybdenum, chromium, sometimes tungsten), Inconel (chromium, iron), Monel metal (copper, iron, manganese), Nichrome (chromium), Nickel-carbon (carbon), Nicrosil (chromium, silicon, magnesium), Nisil (silicon), Nitinol (titanium, shape memory alloy), Magnetically “soft” alloys, Mu-metal (iron), Permalloy (iron, molybdenum), Supermalloy (molybdenum), Brass (copper, zinc, manganese), Nickel hydride (hydrogen), Stainless steel (chromium, molybdenum, carbon, manganese, sulphur, phosphorus, silicon), or Coin silver (nickel). Alloys of plutonium can include Plutonium-aluminum, Plutonium-cerium, Plutonium-cerium-cobalt, Plutonium-gallium (gallium), Plutonium-gallium-cobalt, or Plutonium-zirconium. Alloys of potassium can include NaK (sodium) or KLi (lithium). Rare earth alloys can include Mischmetal (various rare earth elements) or Terfenol-D (terbium, dysprosium, and iron). Alloys of rhodium can include Pseudo palladium (rhodium-silver alloy). Alloys of scandium can include Scandium hydride (hydrogen). Alloys of silver can include Argentium sterling silver (copper, germanium), Billon, Britannia silver (copper), Dore bullion (gold), Electrum (gold), Goloid (copper, gold), Platinum sterling (platinum), Shibuichi (copper), Sterling silver (copper), or Tibetan silver (copper). Alloys of sodium can include NaK (potassium). Alloys of titanium can include Beta C (vanadium, chromium, others), 6al-4v (aluminum, vanadium), Titanium hydride (hydrogen), or Titanium nitride (nitrogen). Alloys of tin can include Babbitt (copper, antimony, lead; used for bearing surfaces), Britannium (copper, antimony), Pewter (antimony, copper), Solder (lead, antimony), or Terne (lead). Alloys of uranium can include Staballoy (depleted uranium with other metals, usually titanium or molybdenum), or Uranium hydride (hydrogen). Alloys of zinc can include Zamak (aluminum, magnesium, copper) or Electroplated zinc alloys. Alloys of zirconium can include Zircaloy (tin) or Zirconium hydride (hydrogen).

As described herein, a sheet metal can comprise alloys comprising components, metals, or auxiliary materials as described above. For example, the alloys can comprise any of the above components, metals, alloys, or auxiliary materials in an amount of about 1%, about 2%, about 3%, about 4%, about 5%, about 6%, about 7%, about 8%, about 9%, about 10%, 11%, about 12%, about 13%, about 14%, about 15%, about 16%, about 17%, about 18%, about 19%, about 20%, 21%, about 22%, about 23%, about 24%, about 25%, about 26%, about 27%, about 28%, about 29%, about 30%, 31%, about 32%, about 33%, about 34%, about 35%, about 36%, about 37%, about 38%, about 39%, about 40%, 41%, about 42%, about 43%, about 44%, about 45%, about 46%, about 47%, about 48%, about 49%, about 50%, 51%, about 52%, about 53%, about 54%, about 55%, about 56%, about 57%, about 58%, about 59%, about 60%, 61%, about 62%, about 63%, about 64%, about 65%, about 66%, about 67%, about 68%, about 69%, about 70%, 71%, about 72%, about 73%, about 74%, about 75%, about 76%, about 77%, about 78%, about 79%, about 80%, 81%, about 82%, about 83%, about 84%, about 85%, about 86%, about 87%, about 88%, about 89%, about 90%, 91%, about 92%, about 93%, about 94%, about 95%, about 96%, about 97%, about 98%, about 99%, or about 100%. It is understood that recitation of the above discrete values includes a range between each recited value. It is understood that recitation of the above ranges includes a discrete values between each recited range.

### Stainless Steel

As described herein, the sheet metal can comprise stainless steel. Stainless steel sheet metal can be manufactured in a variety of grades and compositions.

For example, grade 304 is the most common. It can provide good corrosion resistance while maintaining formability and weldability. Available finishes are #2B, #3, and #4. Grade 316 can provide more corrosion resistance and strength at elevated temperatures than 304. It is commonly used for pumps, valves, chemical equipment, and marine applications. Available finishes are #2B, #3, and #4. Grade 410 is a heat treatable stainless steel, but it can have a lower corrosion resistance than the other grades. It is commonly used in cutlery. The only available finish is dull. Grade 430 is popular grade, low cost alternative to series 300's grades. Grade 430 can be used when high corrosion resistance is not a primary criteria. Grade 430 is a common grade for appliance products, often with a brushed finish. Standard thicknesses can include 0.001″ (1 mil), 0.002″ (2 mil), 0.003″ (3 mil), 0.005″ (5 mil), 0.010″ (10 mil), 0.016″ (16 mil), or 0.020″ (20 mil).

### Copper

As described herein, the sheet metal can comprise copper. Copper sheet metal can be manufactured in a variety of grades and compositions. Finishes for copper sheet metal can include bare (standard), hot tin dipped or tin plated. Copper is a versatile metal relied upon by a variety of industries ranging from electrical to arts and crafts. Standard thicknesses can include 0.001″ (1 mil), 0.003″ (3 mil), 0.005″ (5 mil), 0.010″ (10 mil), 0.016″ (16 mil), or 0.020″ (20 mil).

### Aluminum

As described herein, the sheet metal can comprise aluminum. Aluminum sheet metal can manufactured in a variety of grades and compositions. Aluminum is also a metal used in sheet metal due to its flexibility, wide range of options, cost effectiveness, and other properties. The four most common aluminum grades available as sheet metal are 1100-H14, 3003-H14, 5052-H32, and 6061-T6. Grade 1100-H14 is commercially pure aluminum, highly chemical and weather resistant. It is ductile enough for deep drawing and weldable, but has low strength. It is commonly used in chemical processing equipment, light reflectors, and jewelry. Grade 3003-H14 is stronger than 1100, while maintaining the same formability and low cost. It is corrosion resistant and weldable. It is often used in stampings, spun and drawn parts, mail boxes, cabinets, tanks, and fan blades. Grade 5052-H32 is much stronger than 3003 while still maintaining good formability. It maintains high corrosion resistance and weldability. Common applications include electronic chassis, tanks, and pressure vessels. Grade 6061-T6 is a common heat-treated structural aluminum alloy. It is weldable, corrosion resistant, and stronger than 5052, but not as formable. It loses some of its strength when welded. It is used in modern aircraft structures. Standard thicknesses can include 0.002″ (2 mil) or 0.003″ (3 mil).

### Brass

As described herein, the sheet metal can comprise brass. Standard thicknesses can include 0.005″ (5 mil), 0.010″ (10 mil), 0.015″ (15 mil), or 0.020″ (20 mil).

### Copper, Aluminum, Brass, and Stainless Steel Foil Characteristics

About 0.001″ Copper & 0.002″ Aluminum Foil can tear with fingers, cuts with scissors, often used in scrap booking or other paper-thin crafts. About 0.002″ Stainless Steel Foil can cut with scissors. About 0.003″ Copper & Aluminum Foil doesn't typically tear with fingers, but cuts with scissors, shapes by hand. About 0.005″ Copper & Brass Foil can cut with scissors, shapes by hand, retains shape but with some malleability—an excellent grade for tooling because of its pliability. Indents with a light touch but it will not hold shape if pressure is applied. About 0.010″ Copper & Brass Foil can cut with scissors, shapes by hand, makes 90° bends by hand, retains shape well. About 0.016″ and 0.020″ Copper & Brass Coil can cut with metal snips, can be bent by hand, though 90° bends by hand can be difficult.

### Laminated Material Applications

Laminated materials as described herein can be used in building materials and many other industrial applications. For example, the building material can be ventilation material, duct work material, structural material, or decorative material. Decorative laminates can be produced with a layer of laminate overlay on top of a substrate (e.g., sheet metal). Optionally, a decorative material (e.g., fiber, paper) can be placed between the laminate overlay and the substrate (e.g., sheet metal) before pressing them with thermoprocessing or pressure into decorative laminate (e.g., high-pressure decorative laminates (HPDL)). As another example, a pattern can be pressed into the laminated decorative building material.

Applications for the materials and methods as described herein can be for use in ductwork in HVAC applications, decorative finishes, car bodies, airplane wings, medical tables, roofs for buildings, construction materials, architecture, electrical conduits, pipes, medical devices, containers, and many other applications. Sheet metal of iron and other materials with high magnetic permeability, also known as laminated steel cores, have applications in transformers or electric machines.

A laminated sheet metal, as described herein, can be flexible. For example, the laminated material can be bent, folded, or manipulated by hand. Laminated sheet metals, as described herein, can be waterproof or water resistant.

A laminated sheet metal, as described herein can comprise a plurality of layers. For example, the laminated sheet metal, as described herein can comprise a plurality of layers comprising one or more each of sheet metal, adhesive, or laminate coating composition. As another example, a laminated sheet metal can comprise one or more layers of sheet metal, wherein the one or more layer of sheet metal can be the same sheet metal or different sheet metal. As another example, the laminated sheet metal can comprise one or more layers of adhesive, wherein the one or more layer of adhesive can be the same adhesive or different adhesive. As another example, the laminated sheet metal can comprise one or more layers of laminate coating composition, wherein the one or more layer of laminate coating composition can be the same laminate coating composition or different laminate coating composition.

### Forming Laminated Sheet Metal Materials

The laminated sheet metal material, as described herein can be formed by any process known in the art. Forming sheet metal products are well known in the art. For example, the laminated sheet metal material can be formed byprocesses such as: bending, curling, decambering, deep drawing, expanding, hemming, seeming, incremental sheet forming, ironing, laser cutting, photochemical machining, perforating, press brake forming, punching, roll forming, rolling, spinning, stamping, water jet cutting, or wheeling.

The laminated sheet metal can be shaped into any shape suitable for the application. For example, the laminated metal sheet can be shaped into ovals, circles, round shape, creased, or bent without cracking or breaking. The laminated metal sheet can be mildew and microbial resistant. Materials can be fastened together by any method known in the art. For example, clekos, rivets, sheet metal screws, tape, or adhesive.

As described herein, a laminated sheet metal can have various thicknesses. As described herein, the laminated sheet metal can be at least about 0.1 mil (or 0.0001 in). For example, the laminated sheet metal can have a thickness between about 0.0001 inches and 0.125 inches. As another example, the laminated sheet metal can have a thickness between about 0.0001 inches and 0.02 inches or between about 0.1 mil and about 20 mil. One mil is one thousandth of an inch (0.001″). For example, a laminated sheet metal, as described herein, can have a thickness between 1 mil and about 2 mil. As another example, a laminated sheet metal, as described herein can have a thickness of about 0.10 mil, about 0.15 mil, about 0.20 mil, about 0.25 mil, about 0.30 mil, about 0.35 mil, about 0.40 mil, about 0.45 mil, about 0.50 mil, about 0.55 mil, about 0.60 mil, about 0.65 mil, about 0.70 mil, about 0.80 mil, about 0.85 mil, about 0.90 mil, about 1.0 mil, about 1.10 mil, about 1.15 mil, about 1.20 mil, about 1.25 mil, about 1.30 mil, about 1.35 mil, about 1.40 mil, about 1.45 mil, about 1.50 mil, about 1.55 mil, about 1.60 mil, about 1.65 mil, about 1.70 mil, about 1.80 mil, about 1.85 mil, about 1.90 mil, about 2.0 mil, about 2.10 mil, about 2.15 mil, about 2.20 mil, about 2.25 mil, about 2.30 mil, about 2.35 mil, about 2.40 mil, about 2.45 mil, about 2.50 mil, about 2.55 mil, about 2.60 mil, about 2.65 mil, about 2.70 mil, about 2.80 mil, about 2.85 mil, about 2.90 mil, about 3.0 mil, about 3.10 mil, about 3.15 mil, about 3.20 mil, about 3.25 mil, about 3.30 mil, about 3.35 mil, about 3.40 mil, about 3.45 mil, about 3.50 mil, about 3.55 mil, about 3.60 mil, about 3.65 mil, about 3.70 mil, about 3.80 mil, about 3.85 mil, about 3.90 mil, about 4.0 mil, about 4.10 mil, about 4.15 mil, about 4.20 mil, about 4.25 mil, about 4.30 mil, about 4.35 mil, about 4.40 mil, about 4.45 mil, about 4.50 mil, about 4.55 mil, about 4.60 mil, about 4.65 mil, about 4.70 mil, about 4.80 mil, about 4.85 mil, about 4.90 mil, about 5.0 mil, about 5.10 mil, about 5.15 mil, about 5.20 mil, about 5.25 mil, about 5.30 mil, about 5.35 mil, about 5.40 mil, about 5.45 mil, about 5.50 mil, about 5.55 mil, about 5.60 mil, about 5.65 mil, about 5.70 mil, about 5.80 mil, about 5.85 mil, about 5.90 mil, about 6.0 mil, about 6.10 mil, about 6.15 mil, about 6.20 mil, about 6.25 mil, about 6.30 mil, about 6.35 mil, about 6.40 mil, about 6.45 mil, about 6.50 mil, about 6.55 mil, about 6.60 mil, about 6.65 mil, about 6.70 mil, about 6.80 mil, about 6.85 mil, about 6.90 mil, about 7.0 mil, about 7.10 mil, about 7.15 mil, about 7.20 mil, about 7.25 mil, about 7.30 mil, about 7.35 mil, about 7.40 mil, about 7.45 mil, about 7.50 mil, about 7.55 mil, about 7.60 mil, about 7.65 mil, about 7.70 mil, about 7.80 mil, about 7.85 mil, about 7.90 mil, about 8.0 mil, about 8.10 mil, about 8.15 mil, about 8.20 mil, about 8.25 mil, about 8.30 mil, about 8.35 mil, about 8.40 mil, about 8.45 mil, about 8.50 mil, about 8.55 mil, about 8.60 mil, about 8.65 mil, about 8.70 mil, about 8.80 mil, about 8.85 mil, about 8.90 mil, about 9.0 mil, about 9.10 mil, about 9.15 mil, about 9.20 mil, about 9.25 mil, about 9.30 mil, about 9.35 mil, about 9.40 mil, about 9.45 mil, about 9.50 mil, about 9.55 mil, about 9.60 mil, about 9.65 mil, about 9.70 mil, about 9.80 mil, about 9.85 mil, about 9.90 mil, about 10.0 mil, about 10.10 mil, about 10.15 mil, about 10.20 mil, about 10.25 mil, about 10.30 mil, about 10.35 mil, about 10.40 mil, about 10.45 mil, about 10.50 mil, about 10.55 mil, about 10.60 mil, about 10.65 mil, about 10.70 mil, about 10.80 mil, about 10.85 mil, about 10.90 mil, about 11.0 mil, about 11.10 mil, about 11.15 mil, about 11.20 mil, about 11.25 mil, about 11.30 mil, about 11.35 mil, about 11.40 mil, about 11.45 mil, about 11.50 mil, about 11.55 mil, about 11.60 mil, about 11.65 mil, about 11.70 mil, about 11.80 mil, about 11.85 mil, about 11.90 mil, about 12.0 mil, about 12.10 mil, about 12.15 mil, about 12.20 mil, about 12.25 mil, about 12.30 mil, about 12.35 mil, about 12.40 mil, about 12.45 mil, about 12.50 mil, about 12.55 mil, about 12.60 mil, about 12.65 mil, about 12.70 mil, about 12.80 mil, about 12.85 mil, about 12.90 mil, about 13.0 mil, about 13.10 mil, about 13.15 mil, about 13.20 mil, about 13.25 mil, about 13.30 mil, about 13.35 mil, about 13.40 mil, about 13.45 mil, about 13.50 mil, about 13.55 mil, about 13.60 mil, about 13.65 mil, about 13.70 mil, about 13.80 mil, about 13.85 mil, about 13.90 mil, about 14.0 mil, about 14.10 mil, about 14.15 mil, about 14.20 mil, about 14.25 mil, about 14.30 mil, about 14.35 mil, about 14.40 mil, about 14.45 mil, about 14.50 mil, about 14.55 mil, about 14.60 mil, about 14.65 mil, about 14.70 mil, about 14.80 mil, about 14.85 mil, about 14.90 mil, about 15.0 mil, about 15.10 mil, about 15.15 mil, about 15.20 mil, about 15.25 mil, about 15.30 mil, about 15.35 mil, about 15.40 mil, about 15.45 mil, about 15.50 mil, about 15.55 mil, about 15.60 mil, about 15.65 mil, about 15.70 mil, about 15.80 mil, about 15.85 mil, about 15.90 mil, about 16.0 mil, about 16.10 mil, about 16.15 mil, about 16.20 mil, about 16.25 mil, about 16.30 mil, about 16.35 mil, about 16.40 mil, about 16.45 mil, about 16.50 mil, about 16.55 mil, about 16.60 mil, about 16.65 mil, about 16.70 mil, about 16.80 mil, about 16.85 mil, about 16.90 mil, about 17.0 mil, about 17.10 mil, about 17.15 mil, about 17.20 mil, about 17.25 mil, about 17.30 mil, about 17.35 mil, about 17.40 mil, about 17.45 mil, about 17.50 mil, about 17.55 mil, about 17.60 mil, about 17.65 mil, about 17.70 mil, about 17.80 mil, about 17.85 mil, about 17.90 mil, about 18.0 mil, about 18.10 mil, about 18.15 mil, about 18.20 mil, about 18.25 mil, about 18.30 mil, about 18.35 mil, about 18.40 mil, about 18.45 mil, about 18.50 mil, about 18.55 mil, about 18.60 mil, about 18.65 mil, about 18.70 mil, about 18.80 mil, about 18.85 mil, about 18.90 mil, about 19.0 mil, about 19.10 mil, about 19.15 mil, about 19.20 mil, about 19.25 mil, about 19.30 mil, about 19.35 mil, about 19.40 mil, about 19.45 mil, about 19.50 mil, about 19.55 mil, about 19.60 mil, about 19.65 mil, about 19.70 mil, about 19.80 mil, about 19.85 mil, about 19.90 mil, about 20.0 mil, about 20.10 mil, about 20.15 mil, about 20.20 mil, about 20.25 mil, about 20.30 mil, about 20.35 mil, about 20.40 mil, about 20.45 mil, about 20.50 mil, about 20.55 mil, about 20.60 mil, about 20.65 mil, about 20.70 mil, about 20.80 mil, about 20.85 mil, about 20.90 mil, about 21.0 mil, about 21.10 mil, about 21.15 mil, about 21.20 mil, about 21.25 mil, about 21.30 mil, about 21.35 mil, about 21.40 mil, about 21.45 mil, about 21.50 mil, about 21.55 mil, about 21.60 mil, about 21.65 mil, about 21.70 mil, about 21.80 mil, about 21.85 mil, about 21.90 mil, about 22.0 mil, about 22.10 mil, about 22.15 mil, about 22.20 mil, about 22.25 mil, about 22.30 mil, about 22.35 mil, about 22.40 mil, about 22.45 mil, about 22.50 mil, about 22.55 mil, about 22.60 mil, about 22.65 mil, about 22.70 mil, about 22.80 mil, about 22.85 mil, about 22.90 mil, about 23.0 mil, about 23.10 mil, about 23.15 mil, about 23.20 mil, about 23.25 mil, about 23.30 mil, about 23.35 mil, about 23.40 mil, about 23.45 mil, about 23.50 mil, about 23.55 mil, about 23.60 mil, about 23.65 mil, about 23.70 mil, about 23.80 mil, about 23.85 mil, about 23.90 mil, or about 24.0 mil. It is understood that recitation of the above discrete values includes a range between each recited value. It is understood that recitation of the above ranges includes a discrete values between each recited range.

As another example, the laminated sheet metal can have a thickness of between about 1 mil and 125 mil. For example, the laminated sheet metal thickness can be about 1 mil, about 2 mil, about 3 mil, about 4 mil, about 5 mil, about 6 mil, about 7 mil, about 8 mil, about 9 mil, about 10 mil, 11 mil, about 12 mil, about 13 mil, about 14 mil, about 15 mil, about 16 mil, about 17 mil, about 18 mil, about 19 mil, about 20 mil, 21 mil, about 22 mil, about 23 mil, about 24 mil, about 25 mil, about 26 mil, about 27 mil, about 28 mil, about 29 mil, about 30 mil, 31 mil, about 32 mil, about 33 mil, about 34 mil, about 35 mil, about 36 mil, about 37 mil, about 38 mil, about 39 mil, about 40 mil, 41 mil, about 42 mil, about 43 mil, about 44 mil, about 45 mil, about 46 mil, about 47 mil, about 48 mil, about 49 mil, about 50 mil, 51 mil, about 52 mil, about 53 mil, about 54 mil, about 55 mil, about 56 mil, about 57 mil, about 58 mil, about 59 mil, about 60 mil, 61 mil, about 62 mil, about 63 mil, about 64 mil, about 65 mil, about 66 mil, about 67 mil, about 68 mil, about 69 mil, about 70 mil, 71 mil, about 72 mil, about 73 mil, about 74 mil, about 75 mil, about 76 mil, about 77 mil, about 78 mil, about 79 mil, about 80 mil, 81 mil, about 82 mil, about 83 mil, about 84 mil, about 85 mil, about 86 mil, about 87 mil, about 88 mil, about 89 mil, about 90 mil, 91 mil, about 92 mil, about 93 mil, about 94 mil, about 95 mil, about 96 mil, about 97 mil, about 98 mil, about 99 mil, about 100 mil, 101 mil, about 102 mil, about 103 mil, about 104 mil, about 105 mil, about 106 mil, about 107 mil, about 108 mil, about 109 mil, about 110 mil, 111 mil, about 112 mil, about 113 mil, about 114 mil, about 115 mil, about 116 mil, about 117 mil, about 118 mil, about 119 mil, about 120 mil, 121 mil, about 122 mil, about 123 mil, about 124 mil, or about 125 mil. It is understood that recitation of the above discrete values includes a range between each recited value. It is understood that recitation of the above ranges includes a discrete values between each recited range. A mil is one thousandth of an inch (0.001″).

As described herein, layers of sheet metal, laminate coating composition, or adhesive can partially, substantially, or completely cover a surface. For example, the sheet metal, laminate coating composition, or adhesive can cover a surface of a sheet metal, laminate coating composition, or adhesive with about 1% coverage; about 2% coverage; about 3% coverage; about 4% coverage; about 5% coverage; about 6% coverage; about 7% coverage; about 8% coverage; about 9% coverage; about 10% coverage; about 11% coverage; about 12% coverage; about 13% coverage; about 14% coverage; about 15% coverage; about 16% coverage; about 17% coverage; about 18% coverage; about 19% coverage; about 20% coverage; about 21% coverage; about 22% coverage; about 23% coverage; about 24% coverage; about 25% coverage; about 26% coverage; about 27% coverage; about 28% coverage; about 29% coverage; about 30% coverage; about 31% coverage; about 32% coverage; about 33% coverage; about 34% coverage; about 35% coverage; about 36% coverage; about 37% coverage; about 38% coverage; about 39% coverage; about 40% coverage; about 41% coverage; about 42% coverage; about 43% coverage; about 44% coverage; about 45% coverage; about 46% coverage; about 47% coverage; about 48% coverage; about 49% coverage; about 50% coverage; about 51% coverage; about 52% coverage; about 53% coverage; about 54% coverage; about 55% coverage; about 56% coverage; about 57% coverage; about 58% coverage; about 59% coverage; about 60% coverage; about 61% coverage; about 62% coverage; about 63% coverage; about 64% coverage; about 65% coverage; about 66% coverage; about 67% coverage; about 68% coverage; about 69% coverage; about 70% coverage; about 71% coverage; about 72% coverage; about 73% coverage; about 74% coverage; about 75% coverage; about 76% coverage; about 77% coverage; about 78% coverage; about 79% coverage; about 80% coverage; about 81% coverage; about 82% coverage; about 83% coverage; about 84% coverage; about 85% coverage; about 86% coverage; about 87% coverage; about 88% coverage; about 89% coverage; about 90% coverage; about 91% coverage; about 92% coverage; about 93% coverage; about 94% coverage; about 95% coverage; about 96% coverage; about 97% coverage; about 98% coverage; or about 99% coverage. It is understood that recitation of the above discrete values includes a range between each recited value.

Although the embodiments described herein describe single layers of laminate coatings on either side of a sheet metal and adhesive between the sheet metal and laminate coatings, more than one coating or application of the sheet metal, laminate coating composition, and adhesive may be applied.

### Insulation

The materials, compositions, and methods, as described herein can be suitable for use in HVAC systems, including ductwork and tubing. For example, materials and methods described herein can be used in HVAC applications, such as ductwork, tubing, heating, refrigeration, or ventilation.

For example, the compositions and methods as described herein can comprise insulation material or a plurality of insulation materials. For example, an insulation material can be foam. As another example, a foam can be a thermal insulation foam, an electrical insulation foam, a moisture insulation foam, or a non-foam based material, such as a gel. A ductwork system comprising the laminated sheet metal material can be shaped in such a way to comprise channels.

When at least two channels contain at least two insulation layers, then such insulation layers can be identical to or different from each other in structure, function, material, chemical constituency, density, volume, or any other measurable characteristic. In some embodiments, the insulation layer can include polyurethane. In some embodiments, the insulation layer can be phenolic. In some embodiments, the insulation layer can include or be adhesive, one at least one side. In some embodiments, the insulation layer can be biodegradable, flame-retardant, bacteria-resistant, or leak-proof. In some embodiments, the insulation layer can include a plurality of particles, which can include plastic, metal, wood, glass, stone, rubber, or any other material, whether, whether internally or externally, whether identical to or different from each other. In some embodiments, the insulation layer can have an R-value measuring thermal insulation of at least about 7. However, the R-value of insulation layer can be lower as well. In some embodiments, the insulation layer can be or include a spray foam filler. In some embodiments, the insulation layer is about 1.25 inch thick, about 4 feet long, and has the R-value of about 7.5. In some embodiments, at least one of the channels has a closed end or a partition such that the insulation layer is not visible when viewed from a front of the duct. In some embodiments, the ductwork and the insulation layer have a combined R-value measuring thermal insulation of at least about 8. Such R-value enables the duct 100 to be compliant with at least one building code. However, note that other combined insulation ratings are possible as well, whether for compliance with building codes or other legal codes or environmental aspects, such as the combined insulation R-value of at most about 8, such as between 0.1 and 8. In some embodiments, the insulation layer has the R-value from about 0.5 to about 35 or as appropriate for relevant fluid conduction or surroundings, as described herein. The various materials as described herein can be coupled to the insulation layer, such as via adhering, bonding, sonic sealing, or ultrasonic welding, or other coupling methodologies.

Materials and methods as described herein, are ideal for situations where high strength-to-weight ratio is more important than material cost, such as in HVAC, aerospace, marine, and some automotive applications. Laminated sheet metals can have R values suitable for use in ventilation and ductwork systems. For example, laminated sheet metals, as described herein, can have R values of 0 to 4.

The materials and methods as described herein can comprise an insulating component. For example, the insulating component can be a foam (e.g., polyurethane foam). As another example, the foam can be placed between, on top of, or below, layers of laminate coating composition, sheet metal, or adhesive or combinations thereof. The foam can be rigid or flexible. The foam can have an adhesive on either or both sides for adhering to other foam layers or laminate coating materials, or sheet metal. The foam can be a spray foam. The foam can be placed between the sheet metal or laminate coating composition without adhesive. The foam can have an R value of at least 7. The foam plus the laminated sheet metal material can have a combined R value of at least 8.

Except as otherwise noted herein, compositions and methods of producing insulated ducts and insulated duct work can be carried out as described in International Application No. PCT/US14/48079, filed 24 Jul. 2014, and U.S. application Ser. No. 13/849,644, filed 25 Mar. 2013, issued as U.S. Pat. No. 8,667,995 on 11 Mar. 2014, incorporated by reference in their entireties.

Except as otherwise noted herein, compositions and methods of producing various HVAC ducts can be carried out in accordance with compositions and processes described in U.S. application Ser. No. 15/048,191, filed 19 Feb. 2016, U.S. application Ser. No. 14/153,331, filed 13 Jan. 2014, and U.S. application Ser. No. 13/849,644, filed 25 Mar. 2013, issued as U.S. Pat. No. 8,667,955 on 11 Mar. 2014, incorporated by reference in their entireties.

Except as otherwise noted herein, compositions of various ducts and methods of manufacture, use, and transport of the present disclosure can be carried out in accordance with compositions and processes described in International Application No. PCT/US16/22771, filed 17 Mar. 2016, incorporated herein by reference in its entirety.

Except as otherwise noted herein, compositions of a device comprising an HVAC duct interconnector comprising a tube and a wall extending within the tube described in International Application No. PCT/US16/20060 filed 29 Feb. 2016 is incorporated by reference in its entirety.

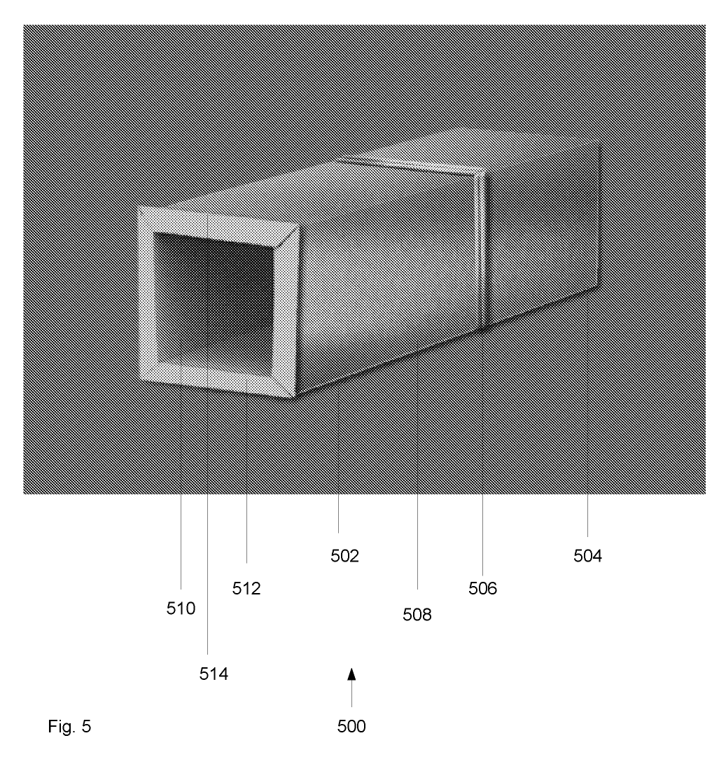

FIG. 5 is a diagram of an embodiment of a ductwork according to this disclosure. In particular, a ductwork 500 includes a first duct 502 and a second duct 504. For example, the ductwork 500 is an HVAC ductwork, although other fluid conduction or storage uses as possible. For example, the ductwork 500 can be as disclosed in U.S. Pat. No. 8,667,995 or PCT/US16/22771 or PCT/US16/20060, all of which are herein fully incorporated by reference herein. The first duct 502 and the second duct 504 are physically coupled to each other at a coupling point 506 such that the first duct 502 and the second duct 504 are in fluid communication with each other, whether gas or liquid. The duct 502 includes an outer tube 508, an inner tube 510, and an end portion cap 512 coupled to the outer tube 508 and the inner tube 510, such as via friction, fastening, adhering, mating, interlocking, friction, bonding, or other ways. The end portion cap 512 includes a lip 514 that assists in tube coupling, as disclosed herein. The end portion cap 512 can include metal, plastic, wood, rubber, or others. Note that the outer tube 508, the inner tube 510, or the end portion cap 512 may include a laminated material, as disclosed herein. Further, note that although the duct 502 or the duct 504 are cross-sectionally square, this structure may vary, such as via being cross-sectionally rectangular, circular, oval, triangular, pentagonal, octagonal, hexagonal, heptagonal, or other cross-sections.

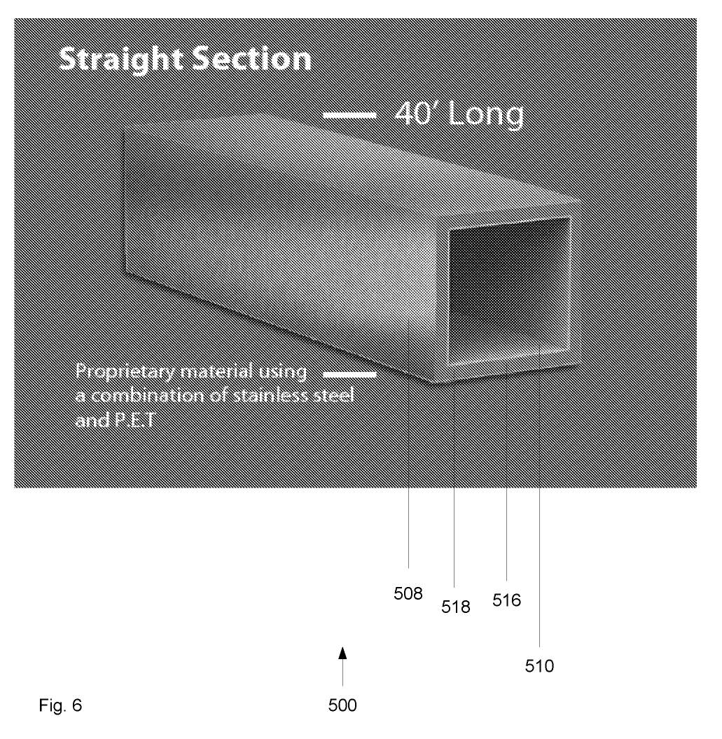

FIG. 6 is a diagram of an embodiment of a ductwork containing an insulator according to this disclosure. In the ductwork 500, the duct 502 includes the outer tube 508 and the inner tube 510 spaced apart from each other such that a cavity 516 is defined therebetween, such as in an open shape, such as a U-shape, or a closed shape, such as an O-shape. The cavity 516 contains a thermal insulator 518 extending between the outer tube 508 and the inner tube 510, such as in an open shape, such as a U-shape, or a closed shape, such as an O-shape. The thermal insulator 518 can be coupled to the outer tube 508 or the inner tube 510, such as via adhering, bonding, friction, or other ways. For example, the thermal insulator 518 can include a foam, a gel, a fiber bundle, or any other thermal insulators. For example, the thermal insulator 518 can include a phenolic foam, a spray foam, a polyurethane foam, a mineral wool, a high temperature insulation wool, or others. Note that the outer tube 508 or the inner tube 510 can include a laminate material, as disclosed herein, such as where the laminate material includes a metal, such as stainless steel, and a plastic, such as PET, with an adhesive positioned therebetween. For example, the metal can be outermost in the outer tube 508 (an exterior face) and innermost in the inner tube 510 (an interior face). Further, although the duct 502 can longitudinally extend 40 inches, other lengths are possible, whether shorter or longer, based on context.

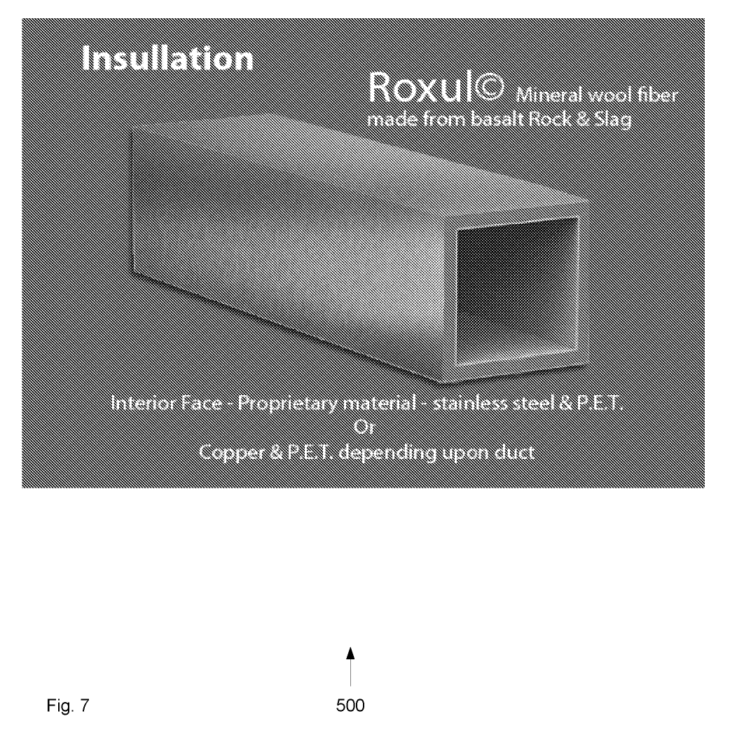

FIG. 7 is a diagram of an embodiment of a ductwork containing a mineral wool fiber according to this disclosure. In the ductwork 500, the thermal insulator 518 extends in a closed shape within the cavity 516, such as in a cross-sectionally square manner, and includes a mineral wool, which may include a basalt rock and a slag wool. However, note that the thermal insulator 518 can extend in other manners, such as an open-shape, and other thermal insulators are possible, such as a foam, a gel, or others. Further, note that the inner tube 510 includes the interior face, such as a metal of a laminated material, as disclosed herein. For example, the metal can include stainless steel, copper, brass, gold, silver, nickel, iron, aluminum, or other metals or alloys.

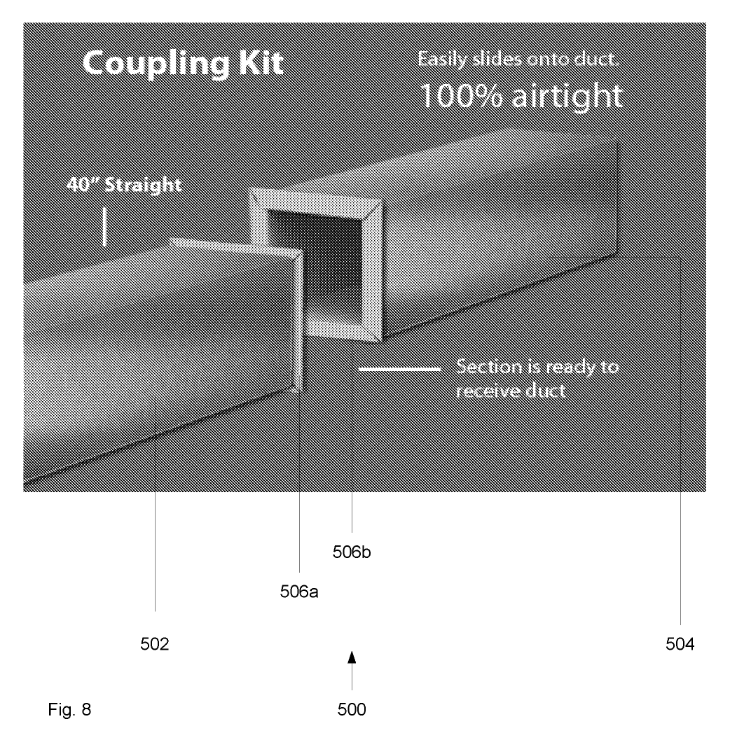

FIG. 8 is a diagram of an embodiment of a pair of ducts prior to coupling according to this disclosure. In the ductwork 500, the duct 502 includes a first coupling portion 506a and the duct 504 includes a second coupling portion 506b, each of which includes the end portion cap 512 for coupling, as disclosed herein.

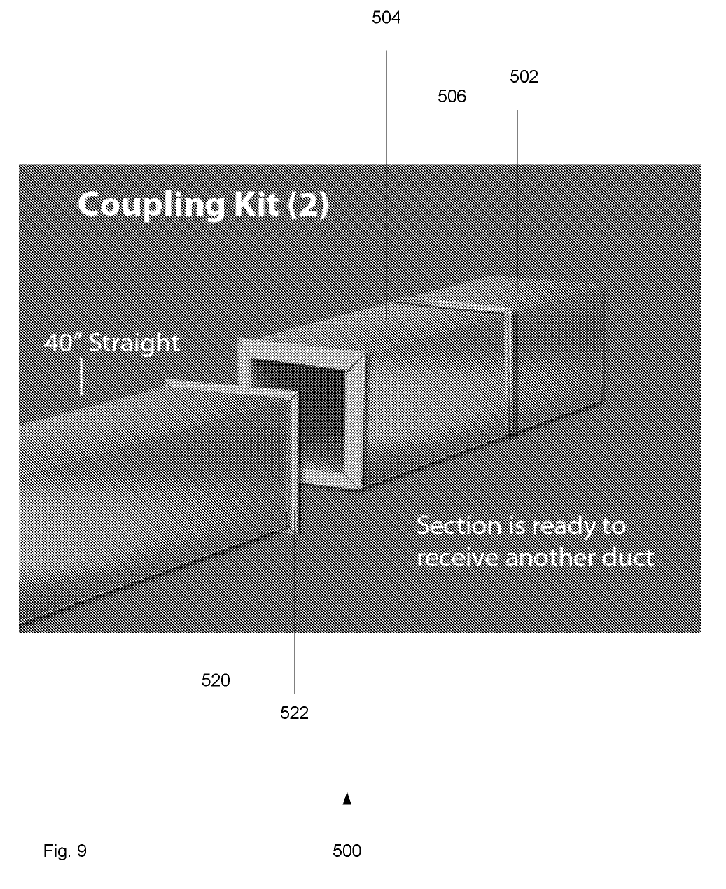

FIG. 9 is a diagram of an embodiment of a ductwork and a duct prior to coupling according to this disclosure. In the ductwork 500, the duct 502 and the duct 504 are coupled to each other at the coupling point 506. As such, a third duct 520 with an end portion cap 522 is ready for coupling with the duct 504 via the end portion cap 512, as disclosed herein.

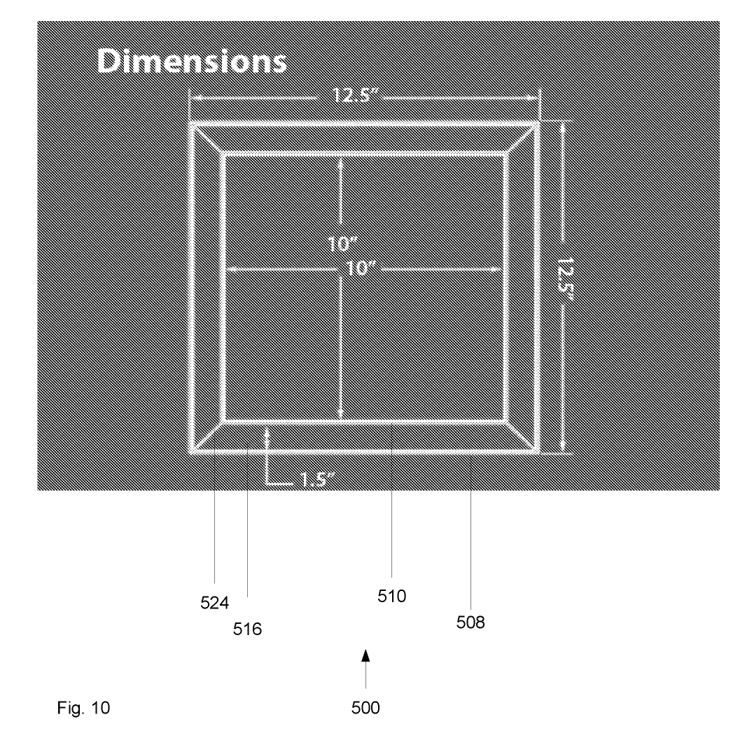

FIG. 10 is a cross-sectional diagram of an embodiment of a duct according to this disclosure. In the ductwork 500, the duct 502 includes the outer tube 508, the inner tube 510, and a plurality of corner walls 524 spanning between the outer tube 508 and the inner tube 510 and longitudinally extending along the outer tube 508 and the inner tube 510 such that the cavities 516 are defined. The cavities 516 can contain the thermal insulators 518, whether same or different from each other. Note that although the cavities 516 are trapezoidal, the cavities 516 can be shaped differently, such as square, rectangular, or others. Further, note that although the outer tube 508 is square shaped and has a 12.5 inches length, this can vary, whether smaller or greater. Similarly, note that although the inner tube 510 is square shaped and has a 10 inch length, this can vary, whether smaller or greater. Likewise, although the cavities 516 have a 1.5 inches height, this can vary, whether smaller or greater.

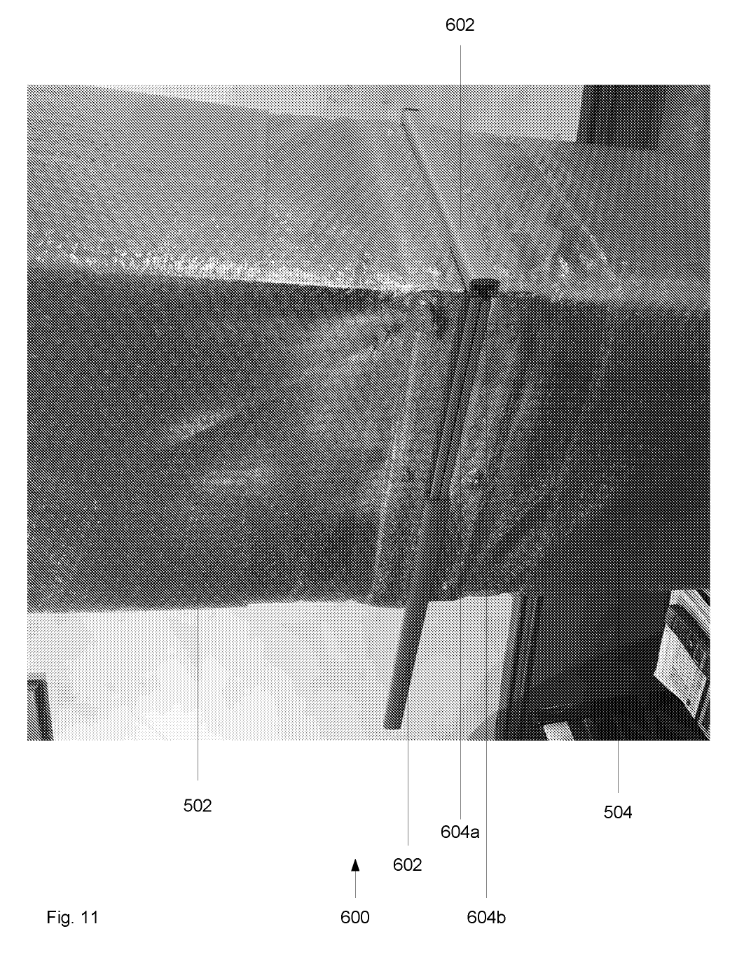

FIG. 11 is an image of a pair of ducts coupled via a coupler according to this disclosure. In particular, a ductwork 600 includes the duct 502 and the duct 504 coupled to each other at the coupling point 506. The duct 502 includes the end cap portion 512a, which defines a first coupling end portion 604a. The duct 504 includes the end cap portion 512b, which defines a second coupling end portion 604b.

The duct 502 is physically coupled to the duct 504 via a plurality of couplers 602, each having an elongated U-shaped portion, an elongated first tail portion, and an elongated second tail portion, where the first tail portion and the second tail portion internally extend from the U-shaped portion toward each other. Although the couplers 602 are shown to slidably couple onto the first coupling portions 604a and the second coupling portions 604b along various planes, other coupling ways are possible, such as mounting, fastening, adhering, mating, interlocking, bracketing, brazing, welding, bonding, or others. Such physical coupling of the duct 502 to the duct 504 enables the duct 502 and the duct 504 to be in fluid communication with each other, whether liquid or gas. The couplers 602 can include metal, plastic, wood, rubber, or other materials.

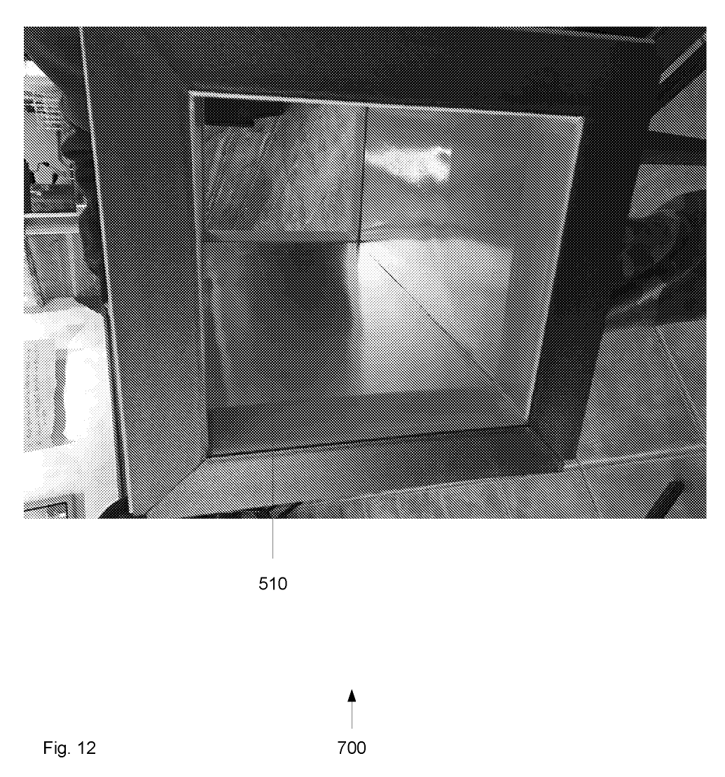

FIG. 12 is an image of a duct with a copper inner surface according to this disclosure. A duct 700 is shown with the inner tube 510 having an innermost surface including copper. However, note that this composition can vary and other metals or alloys are possible, such as brass, gold, silver, nickel, iron, nitrides, carbides, or others.

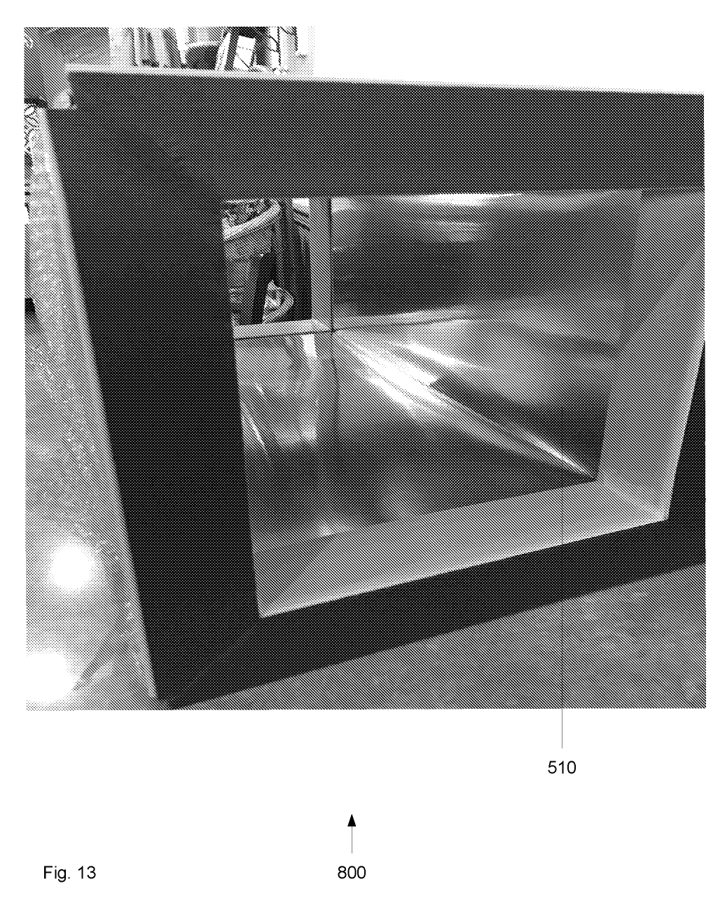

FIG. 13 is an image of a duct with a stainless steel inner surface according to this disclosure. A duct 800 is shown with the inner tube 510 having an innermost surface including stainless steel. However, note that this composition can vary and other metals or alloys are possible, such as brass, gold, silver, nickel, aluminum, nitrides, carbides, or others.

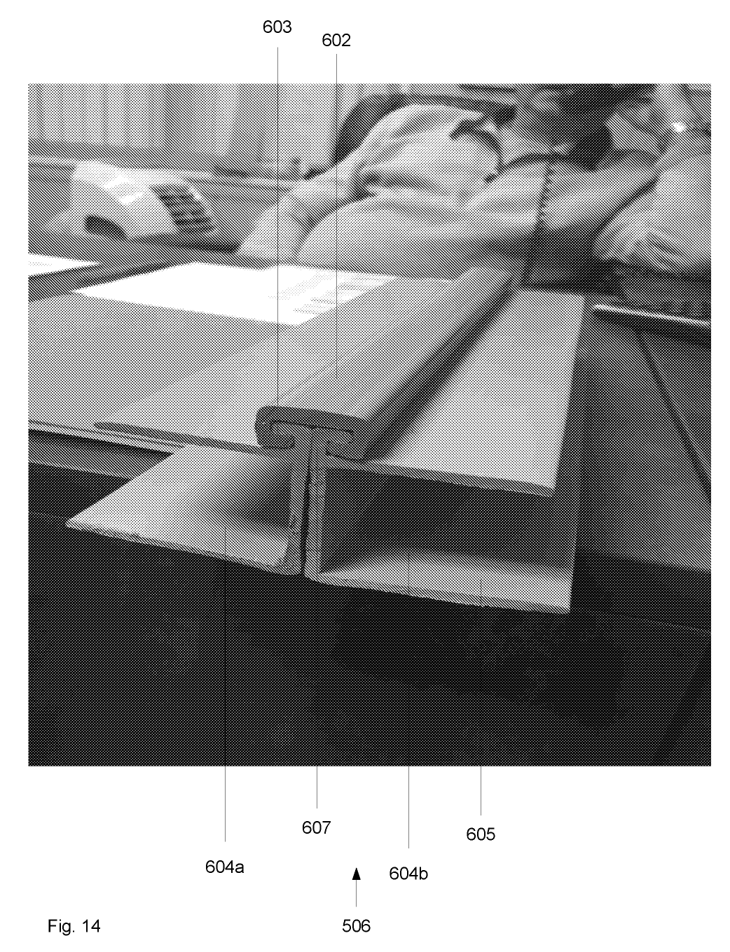

FIG. 14 is an image of a coupler engaging a first duct end portion and a second duct end portion according to this disclosure. The coupling point 506 comprises the first coupling portion 604a, the second coupling portion 604b, and the coupler 602 engaging the first coupling portion 604a and the second coupling portion 604b. In particular, each of the first coupling portion 604a and the second coupling portion 604b includes an elongated U-shaped portion 605 and an elongated L-shaped portion 607. However, note that segmented or discontinuous or spaced apart or alternating configuration is possible, such as a pulsating or sinusoidal shape of the elongated L-shaped portion 607 or other portions, as disclosed herein. For example, the elongated L-shaped portion 607 can be defined via a plurality of L-shapes 607 spaced apart from each other yet extending from the U-shaped portion 605. Similar configuration can formed with the U-shaped portion 605 or the coupler 602.

The L-shaped portion 607 externally extends from the U-shaped portion 605 such that a J-shaped portion is defined. In some embodiments, the first coupling portion 604a and the second coupling portion 604b may be symmetrical to each other. The coupler 602 includes a U-shaped portion and a pair of tail portions 603 internally extending from the U-shaped portion toward each other such that the coupler 602 may be C-shaped. As such, the tail portions 603 engage the J-shaped portions via the L-shaped portions 607 such that the U-shape portion of the coupler 602 contains the L-shaped portions 607 such that the duct 502 is physically coupled to the duct 504 and the duct 502 is in fluid communication with the duct 504. Note that the U-shaped portions 605 may contain the thermal insulators 518 contained in the duct 502 and the duct 504 as shown in FIGS. 5-14.

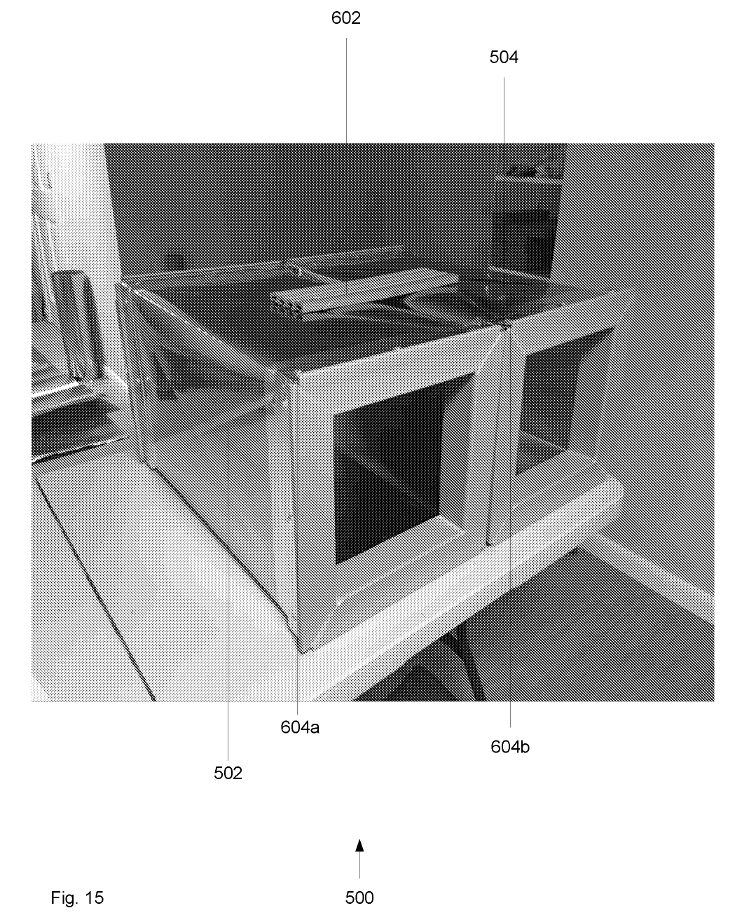

FIG. 15 is an image of a pair of ducts with different inner surfaces prior to coupling via a coupler according to this disclosure. In the ductwork 500, the duct 502 includes the inner tube 510 with the inner face including stainless steel and the duct 504 includes the inner tube 510 with the inner face including copper, where the duct 502 includes the first coupling portion 604a and the duct 504 includes the second coupling portion 604b, each configured for slidable engagement with the couplers 602.

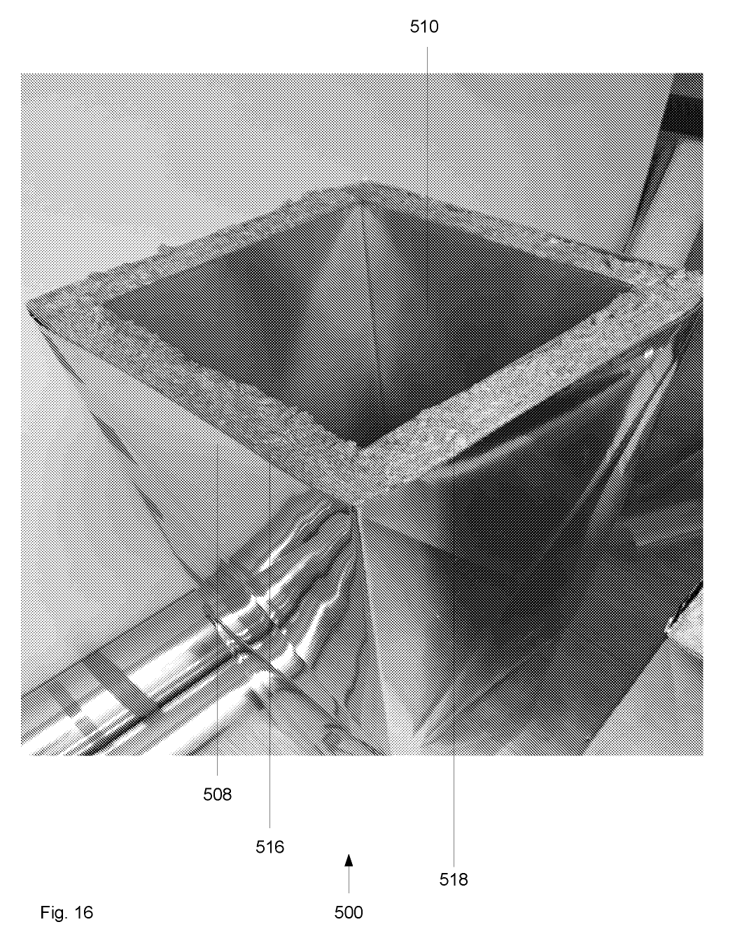

FIG. 16 is an image of a duct with an inner tube, an insulator, and an outer tube according to this disclosure. In the duct 500, the duct 502 contains the outer tube 508 and the inner tube 510 spaced apart from each other to define the cavity 516 that contains the thermal insulator 518. Note that the exterior face of the outer tube 508 includes stainless steel, whereas the inner face of the inner tube 510 include copper, with the thermal insulator 518 including mineral wool and extending in a square shape within the cavity 516 that is also square shaped. In some embodiments, the thermal insulator 518 is adhered to the outer tube 508 and the inner tube 510. Further, note that the end portion cap 512 is removed to expose the cavity 516 and the thermal insulator 518. In some embodiments, the exterior face of the outer tube 508 or the inner face of the inner tube 510 may be attractive to a magnet or include or be magnetic, such as for magnetically attaching an accessory or a sensor.

### EXAMPLES

### Example 1: Laminating the Sheet Metal

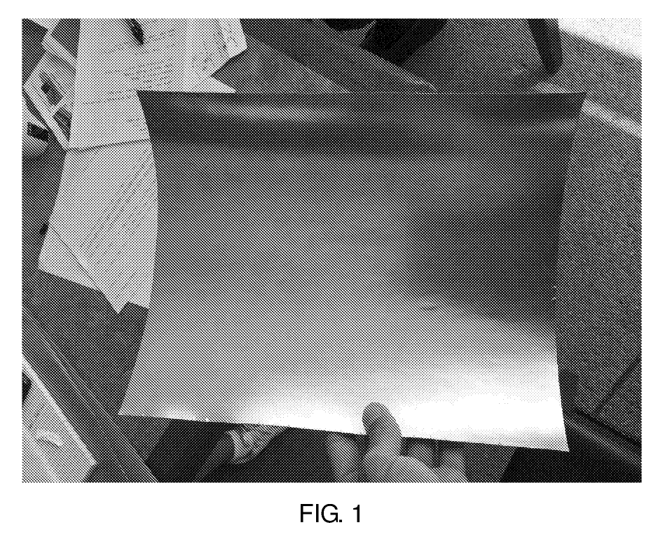

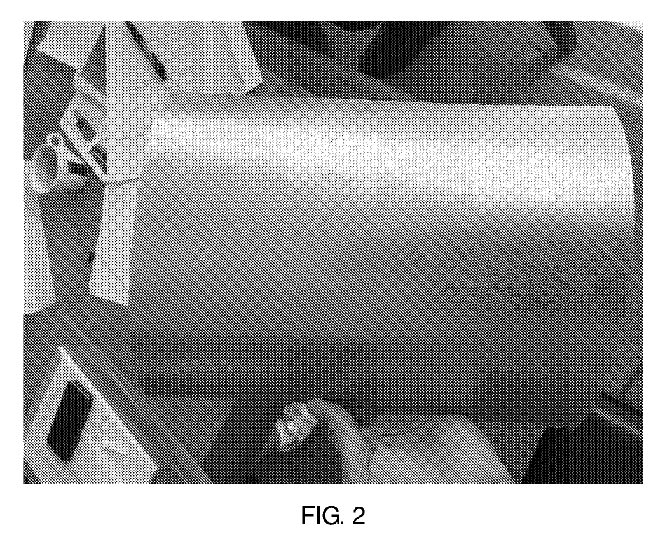

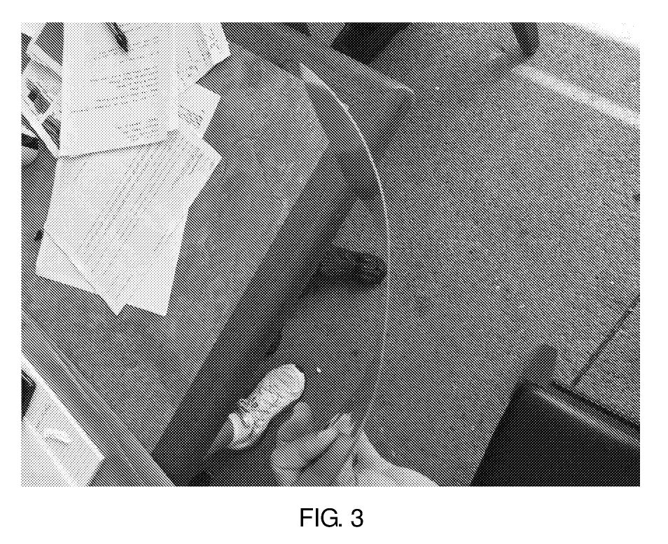

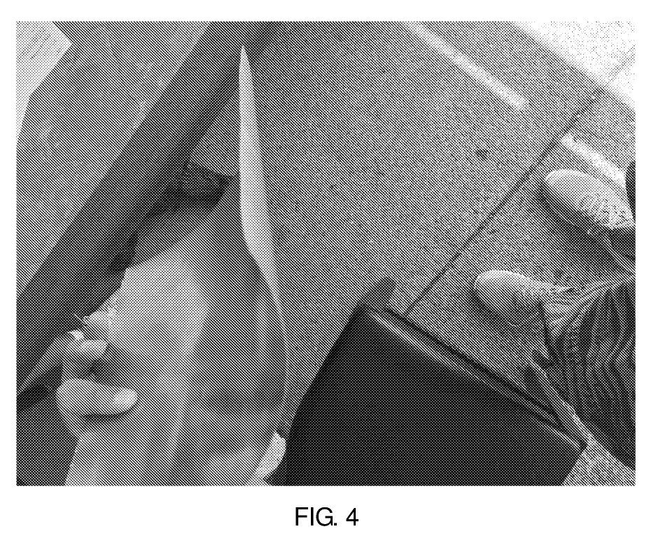

The following example describes the process of making a laminated stainless steel sheet. Components included stainless steel sheet metal, webbed adhesive roll, and extruded PET plastic film obtained from recycled water bottles. The Web Adhesive used in this example was made to pass Underwriters Laboratories (UL) test 181 and UL723. The stainless steel metal sheet (40 in in width, 2 mil thick). The laminate material is an extruded sheet of plastic (40 in wide) obtained from recycled water bottles (PET). The laminate material in this example is 20 mil thick PET plastic sheet. But the plastic sheet can be any plastic and can be of any thickness suitable for use in a flexible laminated sheet metal application. FIG. 1-4 show various views of photographs of the laminated sheet metal material. The top roll was stainless steel, the middle roll was web adhesive, and the bottom roll of PET sheet enters a laminator and are laminated together. The end product is 1 roll of laminated sheet metal material. The machine applied pressure to the layers, heated (about 250° F. with IR heat), and cooled. The components can be placed in any arrangement such that the resulting material results in a flexible laminated sheet metal. For example, the materials can be placed together in the following arrangement: PET plastic film/adhesive sheet/sheet metal/adhesive sheet/PET plastic film and fed through a lamination machine.

### Example 2: Laminated Sheet Metal Material

The following example shows an example of a material suitable for use in ductwork and HVAC systems comprising a Stainless Steel Foil laminated with PET on both sides and between the PET and Stainless Steel Foil is a web adhesive and laminated together (see e.g., FIG. 1-FIG. 4 for the final product). Another example of a laminated sheet metal is a material comprising Copper Foil, laminated with PET on both sides and between the PET and Copper Foil is a web adhesive and laminated together.

### Example 3: Flame Penetration Test

The following example describes the flame penetration test on a laminated stainless steel sheet metal sample. This test measured resistance to flame while the sample supports a static load of 2 pounds per square inch. The test was conducted in a furnace for 30 minutes. To meet Class 1 air duct requirements, the system must withstand UL 181 tests such as rupture, pressure loss, impact, collapse, puncture, static load, and fire retardancy (30 minute flame penetration test). The material made in Example 1 passed the 30 minute flame penetration test. The flame never penetrated the foil. The test ran about 35 minutes at 1500 degrees Fahrenheit.

### Example 4: Laminated Stainless Steel Testing

Methods are as described above unless noted otherwise. The laminated stainless steel was further tested. The material was successfully drilled and perforated without damaging the structural integrity of the material. The laminated material was also found to tolerate pressure printed letters. The laminated stainless steel was also observed to be waterproof and water resistant.

### Example 5: Insulated Laminated Sheet Metal

A laminated sheet metal includes an insulating material, for example, foam. The foam can be a polyurethane foam. The foam can be placed between, on top of, or below, layers of laminate coating composition, sheet metal, or adhesive or combinations thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be fully exhaustive and/or limited to the disclosure in the form disclosed. Many modifications and variations in techniques and structures will be apparent to those of ordinary skill in the art without departing from the scope and spirit of the disclosure as set forth in the claims that follow. Accordingly, such modifications and variations are contemplated as being a part of the present disclosure. The scope of the present disclosure is defined by the claims, which includes known equivalents and unforeseeable equivalents at the time of filing of the present disclosure.

1-20. (canceled)

21. A device comprising:
a laminated material including a first layer, a second layer, and a third layer, wherein the first layer includes a sheet metal, wherein the second layer includes an adhesive, wherein the third layer includes a plastic, wherein the second layer extends between the first layer and the third layer;
a tube including the laminated material, wherein the tube is in fluid communication with a source of a fluid such that the first layer is exposed to the fluid, wherein the source of the fluid includes at least one of a plumbing fixture or a forced gas unit; and
a thermal insulator extending about the laminated material.

22.-32. (canceled)

33. A device comprising:
a first duct including a first coupling portion, wherein the first coupling portion includes a first U-shaped portion and a first L-shaped portion, wherein the first L-shaped portion extends from the first U-shaped portion such that a first J-shaped portion is defined;
a second duct including a second coupling portion, wherein the second coupling portion includes a second U-shaped portion and a second L-shaped portion, wherein the second L-shaped portion extends from the second U-shaped portion such that a second J-shaped portion is defined; and
a coupler including a third U-shaped portion, a first tail portion, and a second tail portion, wherein the first tail portion and the second tail portion extend from the third U-shaped portion toward each other, wherein the first tail portion engages the first J-shaped portion and the second tail portion engages the second J-shaped portion such that the first duct is in fluid communication with the second duct.

34. The device of claim 33, wherein the first duct contains a first thermal insulator within the first U-shaped portion, wherein the second duct contains a second thermal insulator within the second U-shaped portion.

35. The device of claim 33, wherein at least one of the first duct or the second duct includes a flexible material which includes a first layer, a second layer, and a third layer, wherein the first layer includes a sheet metal, wherein the second layer includes an adhesive, wherein the third layer includes a plastic, wherein the second layer extends between the first layer and the third layer.

36. The device of claim 35, wherein the flexible material is able to maintain a structural integrity thereof for about 30 minutes at about 1500 degrees Fahrenheit.

37. The device of claim 36, wherein the flexible material is able to be perforated without damaging the structural integrity thereof.

38. The device of claim 37, wherein the flexible material is at least one of waterproof or water resistant.

39. A method comprising:
accessing a duct including a first tube, a second tube, and an insulator interposed therebetween, wherein the first tube extends within the second tube, wherein the first tube includes a first layer, a second layer, and a third layer, wherein the first layer includes a sheet metal, wherein the second layer includes an adhesive, wherein the third layer includes a plastic, wherein the second layer is interposed between the first layer and the third layer, wherein the third layer faces the insulator;
conducting a conditioned gas through the duct such that the first layer faces the conditioned gas.

40. A method comprising:
accessing a duct including a first tube, a second tube, and an insulator interposed therebetween, wherein the first tube extends within the second tube, wherein the first tube includes a first layer and a second layer, wherein the first layer includes a sheet metal, wherein the second layer includes a plastic, wherein the first layer and the second layer are thermally bonded to each other, wherein the second layer faces the insulator;
conducting a conditioned gas through the duct such that the first layer faces the conditioned gas.

41. The device of claim 21, wherein the source of the fluid includes the plumbing fixture.

42. The device of claim 21, wherein the source of the fluid includes the forced gas unit.
